(19) United States
(12) Patent Application Publication
(10) Pub. No.: US 2009/0068452 A1
(43) Pub. Date: Mar. 12, 2009

(54) BASE MEMBER WITH BONDING FILM, BONDING METHOD AND BONDED BODY

(75) Inventor: Mitsuru SATO, Nagano (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/208,635

(22) Filed: Sep. 11, 2008

(30) Foreign Application Priority Data
Sep. 12, 2007 (JP) 2007-237327

(51) Int. Cl. B32B 7/12; B32B 37/06; B32B 37/10

(52) U.S. Cl. 428/336; 428/343; 156/273.3; 156/60; 156/320; 428/354; 156/272.2

(57) ABSTRACT

A base member with a bonding film that can be firmly bonded to an object with high dimensional accuracy and efficiently bonded to the object at a low temperature, a bonding method which is capable of efficiently bonding such a base member and the object at a low temperature, and a bonded body formed by firmly bonding the base member and the object with high dimensional accuracy and therefore being capable of providing high reliability are provided. The base member is adapted to be bonded to an object through the bonding film thereof. The base member includes a substrate, and a bonding film provided on the substrate, the bonding film containing metal atoms and leaving groups each composed of an organic ingredient, and having a surface, wherein when energy is applied to at least a predetermined region of the surface of the bonding film, the leaving groups, which exist in the vicinity of the surface within the region, are removed from the bonding film so that the region develops a bonding property with respect to the object.

### CROSS-REFERENCE TO RELATED APPLICATION

This application claims a priority to Japanese Patent Application No. 2007-237327 filed on Sep. 12, 2007 is hereby expressly incorporated by reference herein in its entirety.

### BACKGROUND

1. Technical Field

The present invention relates to a base member with a bonding film, a bonding method and a bonded body.

2. Related Art

Conventionally, in the case where two members (base members) are bonded together, an adhesive such as an epoxy-based adhesive, an urethane-based adhesive, or a silicone-based adhesive has been often used.

In general, an adhesive exhibits reliably high adhesiveness regardless of constituent materials of the members to be bonded. Therefore, members formed of various materials can be bonded together in various combinations.

For example, a liquid droplet ejection head (an ink-jet type recording head) included in an ink-jet printer is assembled by bonding, using an adhesive, several members formed of different kinds of materials such as a resin-based material, a metal-based material, and a silicon-based material.

When the members are to be bonded together using the adhesive to obtain an assembled body composed from the members, a liquid or paste adhesive is applied to surfaces of the members, and then the members are attached to each other via the applied adhesive on the surfaces thereof and firmly fixed together by hardening (setting) the adhesive with an action of heat or light.

However, in the case where the members are bonded together using the adhesive, there are problems in that bonding strength between the members is low, dimensional accuracy of the obtained assembled body is low, and it takes a relatively long time until the adhesive is hardened.

Further, it is often necessary to treat the surfaces of the members to be bonded using a primer in order to improve the bonding strength between the members. Therefore, additional cost and labor hour are required for performing the primer treatment, which causes an increase in cost and complexity of the process for bonding the members.

On the other hand, as a method of bonding members without using the adhesive, there is known a solid bonding method. The solid bonding method is a method of directly bonding members without an intervention of an intermediate layer composed of an adhesive or the like (see, for example, JP-A-5-82404).

Since such a solid bonding method does not need to use the intermediate layer composed of the adhesive or the like for bonding the members, it is possible to obtain a bonded body of the members having high dimensional accuracy.

However, in the case where the members are bonded together using the solid bonding method, there are problems in that constituent materials of the members to be bonded are limited to specific kinds, a heat treatment having a high temperature (e.g., about 700 to 800° C.) must be carried out in a bonding process, and an atmosphere in the bonding process is limited to a reduced atmosphere.

In view of such problems, there is a demand for a method which is capable of firmly bonding members with high dimensional accuracy and efficiently bonding them at a low temperature regardless of constituent materials of the members to be bonded.

### SUMMARY

Accordingly, it is an object of the present invention to provide a base member with a bonding film (hereinafter, simply referred to as “a base member”) that can be firmly bonded to an object with high dimensional accuracy and efficiently bonded to the object at a low temperature, a bonding method which is capable of efficiently bonding such a base member and the object at a low temperature, and a bonded body formed by firmly bonding the base member and the object with high dimensional accuracy and therefore being capable of providing high reliability.

A first aspect of the present invention is directed to a base member, the base member being adapted to be bonded to an object through the bonding film thereof.

The base member comprises a substrate, and a bonding film provided on the substrate, the bonding film containing metal atoms and leaving groups each composed of an organic ingredient, and having a surface, wherein when energy is applied to at least a predetermined region of the surface of the bonding film, the leaving groups, which exist in the vicinity of the surface within the region, are removed from the bonding film so that the region develops a bonding property with respect to the object.

This makes it possible to obtain a base member that can be firmly bonded to an object with high dimensional accuracy and efficiently bonded to the object at a low temperature.

In the above base member, it is preferred that the bonding film is obtained by forming an organic metal material as a raw material into a film form using a metal organic chemical vapor deposition method.

According to such a method, it is possible to form a bonding film having an uniform thickness in a relatively simple step.

In the above base member, it is preferred that the bonding film is formed under a low reducing atmosphere.

This makes it possible to effectively prevent or suppress reduction of the organic metal material. As a result, it is possible to form a bonding film in which a part of the organic compound contained in the organic metal material remains therein on the substrate, which is more advantageous than the structure in which a pure metal film containing no organic compound is directly provided on the substrate. In other words, it is possible to form a bonding film having excellent properties of both bonding and metal films.

In the above base member, it is preferred that the leaving groups are derived from a part of an organic compound contained in the organic metal material that remains in the bonding film.

By using residue remaining in the bonding film when forming it as the leaving groups, it is unnecessary to form, in advance, a film such as a metal film into which the leaving groups are to be introduced. This makes it possible to form a bonding film in a relatively simple step.

In the above base member, it is preferred that each of the leaving groups is composed of an atomic group containing a carbon atom as an essential element, and at least one kind selected from the group comprising a hydrogen atom, a nitrogen atom, a phosphorus atom, a sulfur atom and a halogen atom.

Such leaving groups have excellent properties in bonding to and removing from the bonding film when applying the energy thereto. Therefore, the leaving groups can be removed from the bonding film relatively easily and uniformly, which makes it possible to further improve a bonding property of the base member.

In the above base member, it is preferred that each of the leaving groups is an alkyl group.

Since the leaving groups each constituted from the alkyl group exhibit high chemical stability, the bonding film having the alkyl groups as the leaving groups can have excellent weather resistance and chemical resistance.

In the above base member, it is preferred that the organic metal material is a metal complex.

By using the metal complex, it is possible to reliably form a bonding film in which a part of the organic compound contained in the metal complex remains therein.

In the above base member, it is preferred that the metal atoms are at least one kind selected from the group comprising copper, aluminum, zinc and iron.

The bonding film containing these metal atoms can exhibit excellent electrical conductivity.

In the above base member, it is preferred that an abundance ratio of the metal atoms to the carbon atoms contained in the bonding film is in the range of 3:7 to 7:3.

By setting the abundance ratio of the metal atoms to the carbon atoms to the above range, stability of the bonding film becomes high, and it thus becomes possible to firmly bond the base member and the object together. Further, the bonding film can exhibit excellent electrical conductivity.

In the above base member, it is preferred that the bonding film has electrical conductivity.

In the case where a wiring board is formed from a bonded body having such a bonding film, the bonding film can be used as a wiring, a terminal or the like included in the wiring board.

In the above base member, it is preferred that active hands are generated on the surface of the bonding film, after the leaving groups existing at least in the vicinity thereof are removed from the bonding film.

This makes it possible to obtain a base member that can be firmly bonded to the object on the basis of chemical bonds to be produced using the active hands.

In the above base member, it is preferred that each of the active hands is a dangling bond or a hydroxyl group.

This makes it possible for the base member to be especially firmly bonded to the object.

In the above base member, it is preferred that an average thickness of the bonding film is in the range of 1 to 1000 nm.

This makes it possible to prevent dimensional accuracy of the bonded body obtained by bonding the base member and the object together from being significantly reduced, thereby enabling to more firmly bond them together.

In the above base member, it is preferred that the bonding film is in the form of a solid having no fluidity.

In this case, dimensional accuracy of the bonded body obtained by bonding the base member and the object together becomes extremely high as compared to a conventional bonded body obtained using an adhesive. Further, it is possible to firmly bond the base member to the object in a short period of time as compared to the conventional bonded body.

In the above base member, it is preferred that the substrate has a plate shape.

In this case, the substrate can easily bend. Therefore, the substrate becomes sufficiently bendable according to a shape of an object. This makes it possible to improve bonding strength between a base member having such a substrate and the object. Further, since the substrate can easily bend, stress which would be generated in a bonding surface therebetween can be reduced to some extent.

In the above base member, it is preferred that at least a portion of the substrate on which the bonding film is provided is composed of a silicon material, a metal material or a glass material as a major component thereof.

This makes it possible to improve bonding strength of the bonding film against the substrate, even if the substrate is not subjected to a surface treatment.

In the above base member, it is preferred that a surface of the substrate on which the bonding film is provided has been, in advance, subjected to a surface treatment for improving bonding strength between the substrate and the bonding film.

By doing so, the surface of the substrate can be cleaned and activated, and the bonding strength between the bonding film and the substrate becomes higher. This makes it possible to improve bonding strength between the base member and the object.

In the above base member, it is preferred that the surface treatment is a plasma treatment.

Use of the plasma treatment makes it possible to particularly optimize the surface of the substrate so as to be able to form the bonding film thereon.

In the above base member, it is preferred that an intermediate layer provided between the substrate and the bonding film.

This makes it possible to obtain a bonded body having high reliability.

In the above base member, it is preferred that the intermediate layer is composed of an oxide-based material as a major component thereof.

This makes it possible to particularly improve bonding strength between the substrate and the bonding film through the intermediate layer.

A second aspect of the present invention is directed to a bonding method of forming a bonded body in which the above base member and an object are bonded together through the bonding film of the base member.

The bonding method comprises preparing the base member and the object, applying energy to at least a predetermined region of a surface of the bonding film of the base member so that the region develops a bonding property with respect to the object, and making the object and the base member close contact with each other through the bonding film, so that the object and the base member are bonded together due to the bonding property developed in the region, to thereby obtain the bonded body.

This makes it possible to efficiently bond the base member and the object at a low temperature.

A third aspect of the present invention is directed to a bonding method of forming a bonded body in which the above base member and an object are bonded together through the bonding film of the base member, the bonding film having a surface making contact with the object.

The bonding method comprises preparing the base member and the object, making the object and the base member close contact with each other through the bonding film to obtain a laminated body in which the object and the base member are laminated together, and applying energy to at least a predetermined region of the surface of the bonding film in the laminated body, so that the region develops a bonding property with respect to the object and the object and the base member are bonded together due to the bonding property developed in the region, to thereby obtain the bonded body.

This makes it possible to efficiently bond the base member and the object at a low temperature. Further, in the state of the laminated body, the base member and the object are not bonded together. This makes it possible to finely adjust a relative position of the base member with relative to the object easily after they have been laminated together. As a result, it becomes possible to increase positional accuracy of the base member with relative to the object in a direction of the surface of the bonding film.

In the above bonding method, it is preferred that the applying the energy is carried out by at least one method selected from the group comprising a method in which an energy beam is irradiated on the bonding film, a method in which the bonding film is heated and a method in which a compressive force is applied to the bonding film.

Use of these methods makes it possible to relatively easily and efficiently apply the energy to the bonding film.

In the above bonding method, it is preferred that the energy beam is an ultraviolet ray having a wavelength of 126 to 300 nm.

Use of the ultraviolet ray having such a wavelength makes it possible to optimize an amount of the energy to be applied to the bonding film. As a result, the leaving groups in the bonding film can be reliably removed therefrom. This makes it possible for the bonding film to develop a bonding property, while preventing a characteristic thereof such as a mechanical characteristic or a chemical characteristic from being reduced.

In the above bonding method, it is preferred that a temperature of the heating is in the range of 25 to 200° C.

This makes it possible to reliably improve bonding strength between the base member and the object while reliably preventing them (the bonded body) from being thermally altered and deteriorated.

In the above bonding method, it is preferred that the compressive force is in the range of 0.2 to 10 MPa.

This makes it possible to reliably improve bonding strength between the base member and the object, while preventing occurrence of damages and the like in the substrate or the object due to an excess pressure.

In the above bonding method, it is preferred that the applying the energy is carried out in an atmosphere.

By doing so, it becomes unnecessary to spend labor hour and cost for controlling the atmosphere. This makes it possible to easily perform the application of the energy.

In the above bonding method, it is preferred that the object has a surface which has been, in advance, subjected to a surface treatment for improving bonding strength between the object and the base member, and the bonding film of the base member makes close contact with the surface-treated surface of the object.

This make it possible to improve the bonding strength between the base member and the object.

In the above bonding method, it is preferred that the object has a surface containing at least one group or substance selected from the group comprising a functional group, a radical, an open circular molecule, an unsaturated bond, a halogen atom and peroxide, and the bonding film of the base member makes close contact with the surface having the group or substance of the object.

This make it possible to sufficiently improve bonding strength between the base member and the object.

It is preferred that the above bonding method further comprises subjecting the bonded body to a treatment for improving bonding strength between the base member and the object.

This makes it possible to further improve the bonding strength between the base member and the object.

In the above bonding method, it is preferred that the subjecting the treatment is carried out by at least one method selected from the group comprising a method in which an energy beam is irradiated on the bonded body, a method in which the bonded body is heated and a method in which a compressive force is applied to the bonded body.

This makes it possible to further improve the bonding strength between the base member and the object.

A fourth aspect of the present invention is directed to a bonded body. The bonded body comprises the above base member, and an object bonded to the base member through the bonding film thereof.

This makes it possible to obtain a bonded body formed by firmly bonding the base member and the object with high dimensional accuracy. Such a bonded body can have high reliability.

A fifth aspect of the present invention is directed to a bonded body. The bonded body comprises a first base member and a second base member, wherein the first and second base members are bonded together by facing and bonding the bonding films thereof.

This makes it possible to obtain a bonded body formed by firmly bonding the base members together with high dimensional accuracy. Such a bonded body can have high reliability.

### BRIEF DESCRIPTION OF THE DRAWINGS

FIGS. 1A to 1C and 2D to 2F are longitudinal sectional views for explaining a first embodiment of the bonding method of bonding the base member according to the present invention to an object.

FIG. 3 is a partially enlarged view showing a state that before energy is applied to a bonding film of the base member according to the present invention.

FIG. 4 is a partially enlarged view showing a state that after the energy is applied to the bonding film of the base member according to the present invention.

FIG. 5 is a longitudinal sectional view schematically showing a film forming apparatus used for manufacturing the base member according to the present invention.

FIGS. 6A to 6D are longitudinal sectional views for explaining a second embodiment of the bonding method of bonding the base member according to the present invention to an object.

FIGS. 7A to 7D, 8E and 8F are longitudinal sectional views for explaining a third embodiment of the bonding method of bonding the base member according to the present invention to an object.

FIGS. 9A to 9D are longitudinal sectional views for explaining a fourth embodiment of the bonding method of bonding the base member according to the present invention to an object.

FIGS. 10A to 10D are longitudinal sectional views for explaining a fifth embodiment of the bonding method of bonding the base member according to the present invention to an object.

FIGS. 11A to 11D are longitudinal sectional views for explaining a sixth embodiment of the bonding method of bonding the base member according to the present invention to an object.

FIGS. 12A to 12D are longitudinal sectional views for explaining a seventh embodiment of the bonding method of bonding the base member according to the present invention to an object.

FIG. 13 is an exploded perspective view showing an ink jet type recording head (a liquid droplet ejection head) in which the bonded body according to the present invention is used.

FIG. 14 is a section view illustrating major parts of the ink jet type recording head shown in FIG. 13.

FIG. 15 is a schematic view showing one embodiment of an ink jet printer equipped with the ink jet type recording head shown in FIG. 13.

FIG. 16 is a perspective view showing a wiring board in which the bonded body according to the present invention is used.

### DESCRIPTION OF EXEMPLARY EMBODIMENTS

Hereinafter, the base member, the bonding method, and the bonded body according to the present invention will be described in detail with reference to preferred embodiments shown in the accompanying drawings.

The base member of the present invention has a substrate and a bonding film provided on the substrate. In the base member, the bonding film is an organic metal film containing metal atoms and leaving groups each composed of an organic ingredient.

The base member is used for bonding the substrate to an opposite substrate, that is, an object to be bonded to the base member (hereinafter, simply referred to as “an object” on occasion). Specifically, the base member is used for bonding the substrate to the opposite substrate (the object) through the bonding film.

In this regard, this bonding state of the substrate and the opposite substrate will be referred as the expression “the base member is bonded to the opposite substrate (the object)”.

In the base member having such a bonding film, when energy is applied to at least a predetermined region of a surface of the bonding film, that is, a whole region or a partial region of the surface of the bonding film in a plan view thereof, the leaving groups, which exist in the vicinity of the surface within the region, are removed (left) from the bonding film.

This bonding film has a characteristic that the region of the surface, to which the energy has been applied, develops a bonding property with respect to the opposite substrate due to the removal (leaving) of the leaving groups.

According to the present invention, it is possible for the base member having the characteristic described above to firmly bond to the opposite substrate with high dimensional accuracy and to efficiently bond to the opposite substrate at a low temperature.

In addition, by using such a base member, it is possible to obtain a bonded body having high reliability, in which the substrate and the opposite substrate are firmly bonded together through the bonding film.

### First Embodiment

First, description will be made on a first embodiment of each of the base member of the present invention, a bonding method of bonding the base member and an opposite substrate (an object) together, that is, the bonding method of the present invention, and the bonded body of the present invention including the above base member.

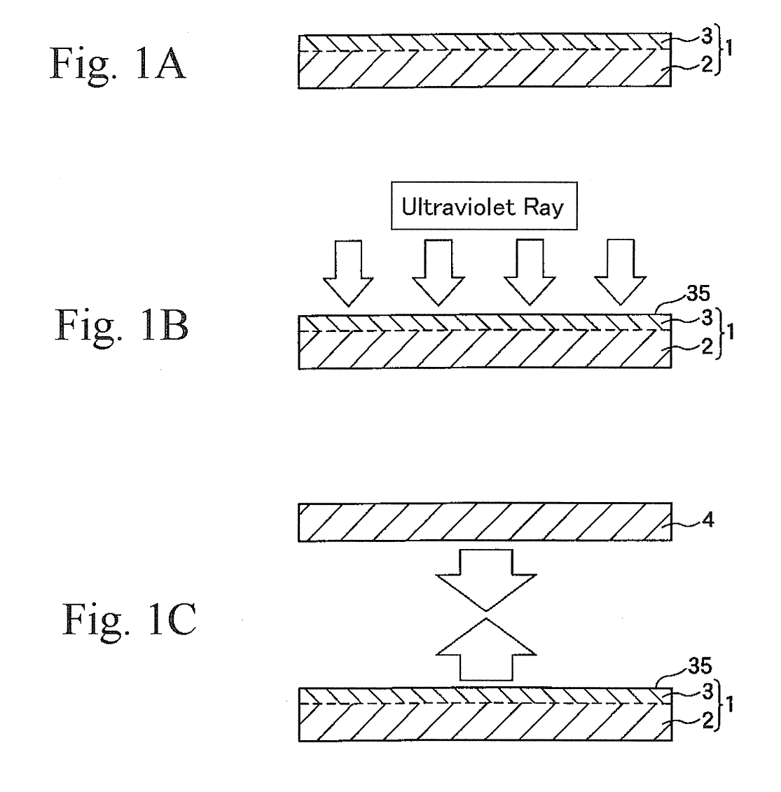

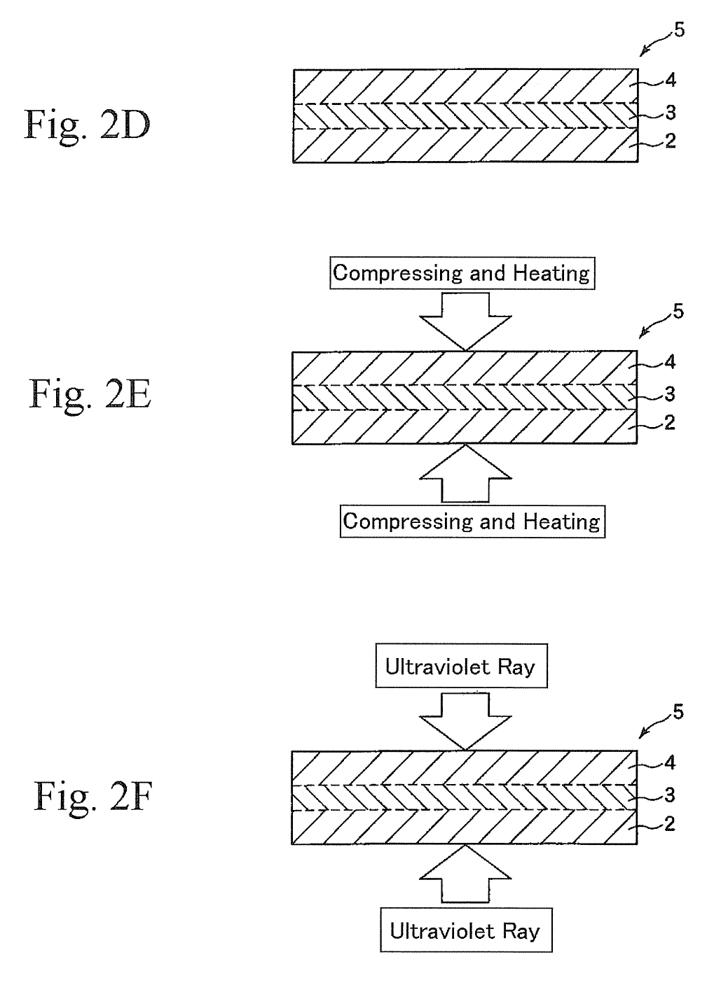

FIGS. 1A to 1C and 2D to 2F are longitudinal sectional views for explaining a first embodiment of the bonding method of bonding the base member according to the present invention to an opposite substrate (an object).

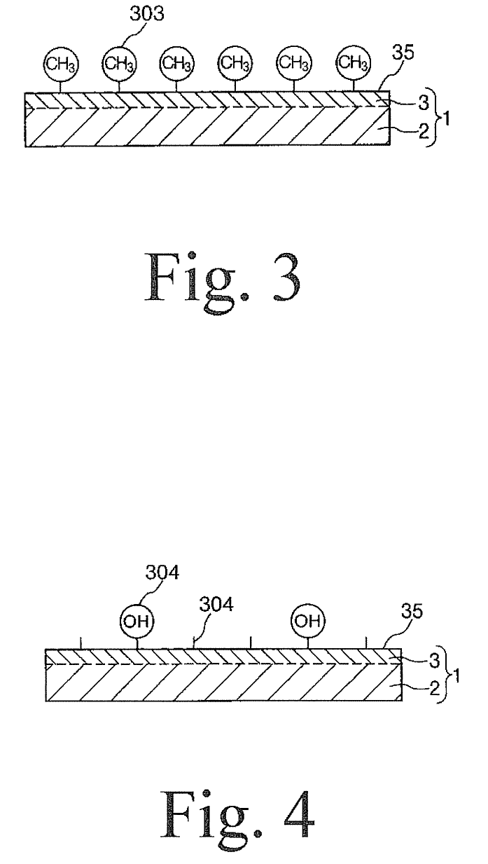

FIG. 3 is a partially enlarged view showing a state that before energy is applied to a bonding film of the base member according to the present invention. FIG. 4 is a partially enlarged view showing a state that after the energy is applied to the bonding film of the base member according to the present invention.

In this regard, it is to be noted that in the following description, an upper side in each of FIGS. 1A to 1C, 2D to 2F, 3 and 4 will be referred to as “upper” and a lower side thereof will be referred to as “lower”.

The bonding method according to this embodiment includes a step of preparing the base member and the opposite substrate, a step of applying the energy to the bonding film of the base member so that it is activated by removing (detaching) the leaving groups therefrom, and a step of making the prepared opposite substrate and the base member close contact with each other through the bonding film so that they are bonded together, to thereby obtain a bonded body.

Hereinafter, the respective steps of the bonding method according to this embodiment will be described one after another.

[1] First, the base member 1 (the base member according to the present invention) is prepared.

As shown in FIG. 1A, the base member 1 includes a substrate (a base) 2 having a plate shape and a bonding film 3 provided on the substrate 2. The substrate 2 may be composed of any material, as long as it has such stiffness that can support the bonding film 3.

Especially, examples of a constituent material of the substrate 2 include: a resin-based material such as polyolefin (e.g., polyethylene, polypropylene, ethylene-propylene copolymer, ethylene-vinyl acetate copolymer (EVA)), cyclic polyolefin, denatured polyolefin, polyvinyl chloride, polyvinylidene chloride, polystyrene, polyamide, polyimide, polyamide-imide, polycarbonate, poly-(4-methylpentene-1), ionomer, acrylic resin, polymethyl methacrylate, acrylonitrile-butadiene-styrene copolymer (ABS resin), acrylonitrile-styrene copolymer (AS resin), butadiene-styrene copolymer, polyoxymethylene, polyvinyl alcohol (PVA), ethylene-vinyl alcohol copolymer (EVOH), polyester (e.g., polyethylene terephthalate (PET), polyethylene naphthalate, polybutylene terephthalate (PBT), polycyclohexane terephthalate (PCT)), polyether, polyether ketone (PEK), polyether ether ketone (PEEK), polyether imide, polyacetal (POM), polyphenylene oxide, denatured polyphenylene oxide, polysulfone, polyether sulfone, polyphenylene sulfide, polyarylate, liquid crystal polymer (e.g., aromatic polyester), fluoro resin (e.g., polytetrafluoroethylene, polyfluorovinylidene), thermoplastic elastomer (e.g., styrene-based elastomer, polyolefin-based elastomer, polyvinylchloride-based elastomer, polyurethane-based elastomer, polyester-based elastomer, polyamide-based elastomer, polybutadiene-based elastomer, trans-polyisoprene-based elastomer, fluororubber-based elastomer, chlorinated polyethylene-based elastomer), epoxy resin, phenolic resin, urea resin, melamine resin, aramid resin, unsaturated polyester, silicone resin, polyurethane, or a copolymer, a blended body and a polymer alloy each having at least one of these materials as a major component thereof; a metal-based material such as a metal (e.g., Fe, Ni, Co, Cr, Mn, Zn, Pt, Au, Ag, Cu, Pd, Al, W, Ti, V, Mo, Nb, Zr, Pr, Nd, Sm), an alloy containing at least one of these metals, carbon steel, stainless steel, indium tin oxide (ITO) or gallium arsenide; a semiconductor-based material such as Si, Ge, InP or GaPN; a silicon-based material such as monocrystalline silicon, polycrystalline silicon or amorphous silicon; a glass-based material such as silicic acid glass (quartz glass), silicic acid alkali glass, soda lime glass, potash lime glass, lead (alkaline) glass, barium glass or borosilicate glass; a ceramic-based material such as alumina, zirconia, ferrite, silicon nitride, aluminum nitride, boron nitride, titanium nitride, carbon silicon, boron carbide, titanium carbide or tungsten carbide; a carbon-based material such as graphite; a complex material containing any one kind of the above materials or two or more kinds of the above materials; and the like.

Further, a surface of the substrate 2 may be subjected to a plating treatment such as a Ni plating treatment, a passivation treatment such as a chromate treatment, a nitriding treatment, or the like.

Furthermore, a shape of the substrate (base) 2 is not particularly limited to a plate shape, as long as it has a shape with a surface which can support the bonding film 3. In other words, examples of the shape of the substrate 2 include a massive shape (blocky shape), a stick shape, and the like.

In this embodiment, since the substrate 2 has a plate shape, it can easily bend. Therefore, the substrate 2 becomes sufficiently bendable according to a shape of an opposite substrate 4 which will be described below in detail. This makes it possible to improve bonding strength between a base member 1 having such a substrate 2 and the opposite substrate 2.

Further, it is also possible to improve bonding strength between the substrate 2 and the bonding film 3 in the base member 1. In addition, since the substrate 2 can easily bend, stress which would be generated in a bonding surface therebetween can be reduced to some extent.

In this case, an average thickness of the substrate 2 is not particularly limited to a specific value, but is preferably in the range of about 0.01 to 10 mm, and more preferably in the range of about 0.1 to 3 mm. Further, it is preferred that the opposite substrate has an average thickness equal to that of the above substrate 2.

When the base member 1 and the opposite substrate 4 are to be bonded together, the bonding film 3 lies between the substrate 2 and the opposite substrate 4, and can join them together. As described above, this bonding film 3 contains the metal atoms and the leaving groups each composed of the organic ingredient (see FIG. 3).

The feature of the base member 1 of the present invention mainly resides on the characteristic of the bonding film 3 which is resulted from the structure thereof. In this regard, it is to be noted that the bonding film 3 will be described later in detail.

Prior to forming the bonding film 3, it is preferred that at least a predetermined region of the substrate 2 where the bonding film 3 is to be formed has been, in advance, subjected to a surface treatment for improving bonding strength between the substrate 2 and the bonding film 3, depending on the constituent material of the substrate 2.

Examples of such a surface treatment include: a physical surface treatment such as a sputtering treatment or a blast treatment; a chemical surface treatment such as a plasma treatment performed using oxygen plasma and nitrogen plasma, a corona discharge treatment, an etching treatment, an electron beam irradiation treatment, an ultraviolet ray irradiation treatment or an ozone exposure treatment; a treatment performed by combining two or more kinds of these surface treatments; and the like.

By subjecting the predetermined region of the substrate 2 where the bonding film 3 is to be formed to such a treatment, it is possible to clean and activate the predetermined region. This makes it possible to improve the bonding strength between the bonding film 3 and the substrate 2.

Among these surface treatments, use of the plasma treatment makes it possible to particularly optimize the surface (the predetermined region) of the substrate 2 so as to be able to form the bonding film 3 thereon.

In this regard, it is to be noted that in the case where the surface of the substrate 2 to be subjected to the surface treatment is formed of a resin material (a polymeric material), the corona discharge treatment, the nitrogen plasma treatment and the like are particularly preferably used.

Depending on the constituent material of the substrate 2, the bonding strength of the bonding film 3 against the substrate 2 becomes sufficiently high even if the surface of the substrate 2 is not subjected to the surface treatment described above.

Examples of the constituent material of the substrate 2 with which such an effect is obtained include materials containing the various kinds of metal-based materials, the various kinds of silicon-based materials, the various kinds of glass-based materials and the like as a major component thereof.

The surface of the substrate 2 formed of such a material is covered with an oxide film. In the oxide film, hydroxyl groups having relatively high activity exist in a surface thereof. Therefore, in this case, it is possible to improve bonding strength of the bonding film 3 against the substrate 2 without subjecting the surface thereof to the surface treatment described above, which makes it possible to firmly bond the base member 1 (the bonding film 3) and the opposite substrate 4.

In this case, the entire of the substrate 2 may not be composed of the above materials, as long as at least the region of the surface of the substrate 2 where the bonding film 3 is to be formed is composed of the above materials.

Further, instead of the surface treatment, an intermediate layer may have been, in advance, provided on at least the predetermined region of the substrate 2 where the bonding film 3 is to be formed. This intermediate layer may have any function.

Such a function is not particularly limited to a specific kind. Examples of the function include: a function of improving binding strength of the substrate 2 to the bonding film 3; a cushion property (that is, a buffering function); a function of reducing stress concentration; a function of accelerating film growth of the bonding film 3 when forming it (that is, a function as a seed layer); a function of protecting the bonding film 3 (that is, a function as a barrier layer); and the like.

By using such a base member in which the substrate 2 and the bonding film 3 are bonded together through the intermediate layer, a bonded body having a high reliability can be obtained.

A constituent material of the intermediate layer include: a metal-based material such as aluminum, titanium, tungsten, copper or an alloy containing these atoms; an oxide-based material such as metal oxide or silicon oxide; a nitride-based material such as metal nitride or silicon nitride; a carbon-based material such as graphite or diamond-like carbon; a self-organization film material such as a silane coupling agent, a thiol-based compound, metal alkoxide or metal halide; a resin-based material such as a resin-based adhesive agent, a resin filming material, various rubbers or various elastomers; and the like, and one or more of which may be used independently or in combination.

Among intermediate layers composed of these various materials, use of the intermediate layer composed of the oxide-based material makes it possible to further improve bonding strength between the substrate 2 and the bonding film 3 through the intermediate layer.

[2] Next, the energy is applied to a surface 35 of the bonding film 3 of the base member 1.

When the energy is applied to the bonding film 3, as shown in FIGS. 3 and 4, bonds of at least a part of the leaving groups 303 are broken and the at least a part of the leaving groups 303 are removed from the vicinity of the surface 35 of the bonding film 3. After the leaving groups 303 have been removed, active hands 304 are generated in the vicinity of the surface 35 of the bonding film 3.

As a result, the surface 35 of the bonding film 3 develops the bonding property with respect to the opposite substrate 4, that is, the bonding film 3 is activated. The base member 1 having such a state can be firmly bonded to the opposite substrate 4 on the basis of chemical bonds to be produced using the active hands 304.

The energy may be applied to the bonding film 3 by any method. Examples of the method include: a method in which an energy beam is irradiated on the bonding film 3; a method in which the bonding film 3 is heated; a method in which a compressive force (physical energy) is applied to the bonding film 3; a method in which the bonding film 3 is exposed to plasma (that is, plasma energy is applied to the bonding film 3); a method in which the bonding film 3 is exposed to an ozone gas (that is, chemical energy is applied to the bonding film 3); and the like.

Among these methods, in this embodiment, it is particularly preferred that the method in which the energy beam is irradiated on the bonding film 3 is used as the method in which the energy is applied to the bonding film 3. Since such a method can efficiently apply the energy to the bonding film 3 relatively easily, the method is suitably used as the method of applying the energy.

Examples of the energy beam include: a ray such as an ultraviolet ray or a laser beam; a particle beam such as a X ray, a y ray, an electron beam or an ion beam; and combinations of two or more kinds of these energy beams.

Among these energy beams, it is particularly preferred that an ultraviolet ray having a wavelength of about 126 to 300 nm is used (see FIG. 1B). Use of the ultraviolet ray having such a wavelength makes it possible to optimize an amount of the energy to be applied to the bonding film 3.

As a result, the leaving groups 303 in the bonding film 3 can be reliably removed therefrom. This makes it possible for the bonding film 3 to develop a bonding property, while preventing a characteristic thereof such as a mechanical characteristic or a chemical characteristic from being reduced.

Further, the use of the ultraviolet ray makes it possible to process a wide area of the surface 35 of the bonding film 3 without unevenness in a short period of time. Therefore, the removal (leaving) of the leaving groups 303 can be efficiently performed.

Moreover, such an ultraviolet ray has, for example, an advantage that it can be generated by simple equipment such as an UV lamp. In this regard, it is to be noted that the wavelength of the ultraviolet ray is more preferably in the range of about 126 to 200 nm.

In the case where the UV lamp is used, power of the UV lamp is preferably in the range about of 1 mW/cm² to 1 W/cm², and more preferably in the range of about 5 to 50 mW/cm², although being different depending on an area of the surface 35 of the bonding film 3. In this case, a distance between the UV lamp and the bonding film 3 is preferably in the range of about 1 to 10 mm, and more preferably in the range of about 1 to 5 mm.

Further, a time for irradiating the ultraviolet ray is preferably set to a time enough for removing the leaving groups 303 from the vicinity of the surface 35 of the bonding film 3, i.e., a time enough for preventing the ultraviolet ray from being irradiated on the bonding film 3 more than necessary. This makes it possible to efficiently prevent the bonding film 3 from being altered and deteriorated.

Specifically, the time is preferably in the range of about 0.5 to 30 minutes, and more preferably in the range of about 1 to 10 minutes, although being slightly different depending on an amount of the ultraviolet ray, the constituent material of the bonding film 3, and the like. The ultraviolet ray may be irradiated temporally continuously or intermittently (in a pulse-like manner).

On the other hand, examples of the laser beam include: a pulse oscillation laser (a pulse laser) such as an excimer laser; a continuous oscillation laser such as a carbon dioxide laser or a semiconductor laser; and the like. Among these lasers, it is preferred that the pulse laser is used. Use of the pulse laser makes it difficult to accumulate of heat in a portion of the bonding film 3 where the laser beam is irradiated with time.

Therefore, it is possible to reliably prevent alteration and deterioration of the bonding film 3 due to the heat accumulated. In other words, the use of the pulse laser makes it possible to prevent the heat accumulated from affecting the inside of the bonding film 3.

In the case where influence of the heat is taken into account, a pulse width of the pulse laser is preferably as small as possible. Specifically, the pulse width is preferably equal to or smaller than 1 ps (picosecond), and more preferably equal to or smaller than 500 fs (femtoseconds).

By setting the pulse width to the above range, it is possible to reliably suppress the influence of the heat generated in the bonding film 3 due to the irradiation of the laser beam. In this regard, it is to be noted that the pulse laser having the small pulse width of the above range is called “femtosecond laser”.

A wavelength of the laser beam is not particularly limited to a specific value, but is preferably in the range of about 200 to 1200 nm, and more preferably in the range of about 400 to 1000 nm. Further, in the case of the pulse laser, peak power of the laser beam is preferably in the range of about 0.1 to 10 W, and more preferably in the range of about 1 to 5 W, although being different depending on the pulse width thereof.

Moreover, a repetitive frequency of the pulse laser is preferably in the range of about 0.1 to 100 kHz, and more preferably in the range of about 1 to 10 kHz. By setting the frequency of the pulse laser to the above range, a temperature of a portion where the laser beam is irradiated extremely rises and the leaving groups 303 can be reliably broken (removed) from the vicinity of the surface 35 of the bonding film 3 in a state that a part of the organic ingredient remains therein.

By appropriately setting various conditions for such a laser beam, the temperature in the portion where the laser beam is irradiated is adjusted so as to be preferably in the range of about normal temperature (room temperature) to 600° C., more preferably in the range of about 200 to 600° C., and still more preferably in the range of about 300 to 400° C. The adjustment of the temperature in the region to the above range makes it possible to reliably remove the leaving groups 303 from the bonding film 3.

The laser beam irradiated on the bonding film 3 is preferably scanned along the surface 35 of the bonding film 3 with a focus thereof set on the surface 35. By doing so, heat generated by the irradiation of the laser beam is locally accumulated in the vicinity of the surface 35. As a result, it is possible to selectively remove the leaving groups 303 existing in the vicinity of the surface 35 of the bonding film 3.

Further, the irradiation of the energy beam on the bonding film 3 may be performed in any atmosphere. Specifically, examples of the atmosphere include: an oxidizing gas atmospheres such as atmosphere (air) or an oxygen gas; a reducing gas atmospheres such as a hydrogen gas; an inert gas atmospheres such as a nitrogen gas or an argon gas; a decompressed (vacuum) atmospheres obtained by decompressing these atmospheres; and the like.

Among these atmospheres, the irradiation is particularly preferably performed in the atmosphere. As a result, it becomes unnecessary to spend labor hour and cost for controlling the atmosphere. This makes it possible to easily perform (carry out) the irradiation of the energy beam.

In this way, according to the method of irradiating the energy beam, the energy can be easily applied to the vicinity of the surface 35 of the bonding film 3 selectively. Therefore, it is possible to prevent, for example, alteration and deterioration of the substrate 2 and the bonding film 3, i.e., alteration and deterioration of the base member 1 due to the application of the energy.

Further, according to the method of irradiating the energy beam, a degree of the energy to be applied can be accurately and easily controlled. Therefore, it is possible to adjust the number of the leaving groups 303 to be removed from the bonding film 3. By adjusting the number of the leaving groups 303 to be removed from the bonding film 3 in this way, it is possible to easily control bonding strength between the base member 1 and the opposite substrate 4.

In other words, by increasing the number of the leaving groups 303 to be removed, since a large number of active hands 304 are generated in the vicinity of the surface 35 of the bonding film 3, it is possible to further improve a bonding property developed in the bonding film 3.

On the other hand, by reducing the number of the leaving groups 303 to be removed, it is possible to reduce the number of the active hands 304 generated in the vicinity of the surface 35 of the bonding film 3 and suppress a bonding property developed in the bonding film 3.

In order to adjust magnitude of the applied energy, for example, conditions such as the kind of the energy beam, the power of the energy beam, and the irradiation time of the energy beam only have to be controlled.

Moreover, according to the method of irradiating the energy beam, since large energy can be applied in a short period of time, it is possible to more efficiently apply energy on the bonding film 3.

As shown in FIG. 3, the bonding film 3 before the application of the energy has the leaving groups 303 in the vicinity of the surface 35 thereof. When the energy is applied to such a bonding film 3, the leaving groups 303 (methyl groups in FIG. 3) are removed from the bonding film 3. At this time, as shown in FIG. 4, the active hands 304 are generated on the surface 35 of the bonding film 3. As a result, a bonding property is developed on the surface 35 of the bonding film 3.

Here, in this specification, a state that the bonding film 3 is “activated” means: a state that the leaving groups 303 existing on the surface 35 and in the inside of the bonding film 3 are removed as described above, and atoms constituting the bonding film 3, from which the leaving groups 303 are removed (left), are not terminated so that “dangling bonds (or uncoupled bonds)” are generated; a state that the atoms having the dangling bonds (the unpaired electrons) are terminated by hydroxyl groups (OH groups) and the hydroxyl groups exist on the surface 35 of the bonding film 3; and a state that the dangling bonds and the hydroxyl groups coexist on the surface 35 of the bonding film 3.

Therefore, as shown in FIG. 4, the active hands 304 refer to the dangling bonds and/or the hydroxyl groups bonded to the atoms which have had the dangling bonds. If such active hands 304 exist on the surface 35 of the bonding film 3, it is possible to particularly firmly bond the base member 1 to the opposite substrate 4 through the bonding film 3.

In this regard, the latter state (that is, the state that the atoms which have had the dangling bonds are terminated by the hydroxyl groups) is easily generated, because, for example, when the energy beam is merely irradiated on the bonding film 3 in the atmosphere, water molecules contained therein bond to the atoms which have had the dangling bonds and they are terminated by the hydroxyl groups.

In this embodiment, before the base member 1 and the opposite substrate 4 are laminated together, the energy has been applied to the bonding film 3 of the base member 1 in advance. However, such energy may be applied at a time when the base member 1 and the opposite substrate 4 are laminated together or after the base member 1 and the opposite substrate 4 have been laminated together. Such a case will be described in a second embodiment described below.

[3] The opposite substrate (the object) 4 is prepared. As shown in FIG. 1C, the base member 1 makes close contact with the opposite substrate 4 through the bonding film 3 thereof. At this time, since the bonding film 3 has developed the bonding property with respect to the opposite substrate 4 in the step [2], the bonding film 3 and the opposite substrate 4 are chemically bonded together. As a result, the base member 1 is bonded to the opposite substrate 4, to thereby obtain a bonded body 5 shown in FIG. 2D.

In the bonded body 5 obtained in this way, the base member 1 and the opposite substrate 4 are bonded together by firm chemical bonds formed in a short period of time such as a covalent bond, unlike bond (adhesion) mainly based on a physical bond such as an anchor effect by using the conventional adhesive. Therefore, it is possible to obtain a bonded body 5 in a short period of time, and to prevent occurrence of peeling, bonding unevenness and the like in the bonded body 5.

Further, according to such a method of manufacturing the bonded body 5 using the base member 1, a heat treatment at a high temperature (e.g., a temperature equal to or higher than 700° C.) is unnecessary unlike the conventional solid bonding method. Therefore, the substrate 2 and the opposite substrate 4 each formed of a material having low heat resistance can also be used for bonding them.

In addition, the substrate 2 and the opposite substrate 4 are bonded together through the bonding film 3. Therefore, there is also an advantage that each of the constituent materials of the substrate 2 and the opposite substrate 4 is not limited to a specific kind. For these reasons, according to the present invention, it is possible to expand selections of the constituent materials of the substrate 2 and the opposite substrate 4.

Moreover, in the conventional solid bonding method, the substrate 2 and the opposite substrate 4 are bonded together without intervention of a bonding layer. Therefore, in the case where the substrate 2 and the opposite substrate 4 exhibit a large difference in their thermal expansion coefficients, stress based on the difference tends to concentrate on a bonding interface therebetween. It is likely that peeling of the bonding interface and the like occur.

However, since the bonded body (the bonded body of the present invention) 5 has the bonding film 3, the concentration of the stress which would be generated is reduced due to the presence thereof. This makes it possible to accurately suppress or prevent occurrence of peeling in the bonded body 5.

Further, in this embodiment, the bonding film 3 is provided on only one of the substrate 2 and the opposite substrate 4 which are to be bonded together (in this embodiment, the substrate 2). Therefore, in the case where the bonding film 3 is formed on the substrate 2 using a plasma treatment, the substrate 2 is exposed to plasma for a relatively long period of time. On the other hand, in this embodiment, the opposite substrate 4 is not exposed to the plasma at all.

For reason, even if an opposite substrate 4 having low durability against the plasma is used, the base member 1 and the opposite substrate 4 can be firmly bonded together according to the bonding method of this embodiment. Therefore, there is a merit that the constituent materials of the opposite substrate 4 can be selected from expanded materials without considering durability thereof against the plasma.

Like the substrate 2, the opposite substrate 4 to be bonded to the base member 1 may be formed of any material. Specifically, the opposite substrate 4 can be formed of the same material as that constituting the substrate 2.

Further, like the substrate 2, a shape of the opposite substrate 4 is not particularly limited to a specific type, as long as it has a shape with a surface which can bond to the bonding film 3. Examples of the shape of the opposite substrate 4 include a plate shape (a film shape), a massive shape (a blocky shape), a stick shape, and the like.

Although the constituent material of the opposite substrate 4 may be different from or the same as that of the substrate 2, it is preferred that the substrate 2 and the opposite substrate 4 have substantially equal thermal expansion coefficients with each other.

In the case where the substrate 2 and the opposite substrate 4 have the substantially equal thermal expansion coefficients with each other, when the base member 1 and the opposite substrate 4 are bonded together, stress due to thermal expansion is less easily generated on a bonding interface therebetween. As a result, it is possible to reliably prevent occurrence of deficiencies such as peeling in the bonded body 5 finally obtained.

Further, in the case where the substrate 2 and the opposite substrate 4 have a difference in their thermal expansion coefficients with each other, it is preferred that conditions for bonding between the base member 1 and the opposite substrate 4 are optimized as follows. This makes it possible to firmly bond the base member 1 and the opposite substrate 4 together with high dimensional accuracy.

In other words, in the case where the substrate 2 and the opposite substrate 4 have the difference in their thermal expansion coefficients with each other, it is preferred that the base member 1 and the opposite substrate 4 are bonded together at as low temperature as possible. If they are bonded together at the low temperature, it is possible to further reduce thermal stress which would be generated on the bonding interface therebetween.

Specifically, the base member 1 and the opposite substrate 4 are bonded together in a state that each of the substrate 2 and the opposite substrate 4 is heated preferably at a temperature of about 25 to 50° C., and more preferably at a temperature of about 25 to 40° C., although being different depending on the difference between the thermal expansion coefficients thereof.

In such a temperature range, even if the difference between the thermal expansion coefficients of the substrate 2 and the opposite substrate 4 is rather large, it is possible to sufficiently reduce thermal stress which would be generated on the bonding interface between the base member 1 (the bonding film 3) and the opposite substrate 4. As a result, it is possible to reliably suppress or prevent occurrence of warp, peeling or the like in the bonded body 5.

Especially, in the case where the difference between the thermal expansion coefficients of the substrate 2 and the opposite substrate 4 is equal to or larger than 5×10⁵/K, it is particularly recommended that the base member 1 and the opposite substrate 4 are bonded together at a low temperature as much as possible as described above. Moreover, it is preferred that the substrate 2 and the opposite substrate 4 have a difference in their rigidities. This makes it possible to more firmly bond the base member 1 and the opposite substrate 4 together.

Further, it is preferred that at least one substrate of the substrate 2 and the opposite substrate 4 is composed of a resin material. The substrate composed of the resin material can be easily deformed due to plasticity of the resin material itself.

Therefore, it is possible to reduce stress which would be generated on the bonding surface between the substrate 2 and the opposite substrate 4 (e.g., stress due to thermal expansion thereof). As a result, breaking of the bonding surface becomes hard. This makes it possible to obtain a bonded body 5 having high bonding strength between the base member 1 and the opposite substrate 4.

Before the base member 1 and the opposite substrate 4 are bonded together, it is preferred that a predetermined region of the above mentioned opposite substrate 4 to which the base member 1 is to be bonded has been, in advance, subjected to the same surface treatment as employed in the substrate 2, depending on the constituent material of the opposite substrate 4.

In this case, the surface treatment is a treatment for improving bonding strength between the base member 1 and the opposite substrate 4. By subjecting the region of the opposite substrate 4 to the surface treatment, it is possible to further improve the bonding strength between the base member 1 and the opposite substrate 4.

In this regard, it is to be noted that the opposite substrate 4 can be subjected to the same surface treatment as the above mentioned surface treatment to which the substrate 2 is subjected.

Depending on the constituent material of the opposite substrate 4, the bonding strength between the base member 1 and the opposite substrate 4 becomes sufficiently high even if the surface of the opposite substrate 4 is not subjected to the surface treatment described above.

Examples of the constituent material of the opposite substrate 4 with which such an effect is obtained include the same material as that constituting the substrate 2, that is, the various kinds of metal-based materials, the various kinds of silicon-based materials, the various kinds of glass-based materials and the like.

Furthermore, if the region of the surface of the opposite substrate 4, to which the base member 1 is to be bonded, has the following groups and substances, the bonding strength between the base member 1 and the opposite substrate 4 can become sufficiently high even if the region is not subjected to the surface treatment described above.

Examples of such groups and substances include at least one group or substance selected from the group comprising a hydrogen atom, a functional group such as a hydroxyl group, a thiol group, a carboxyl group, an amino group, a nitro group or an imidazole group, a radical, an open circular molecule, an unsaturated bond such as a double bond or a triple bond, a halogen atom such as a F atom, a Cl atom, a Br atom or an I atom, and peroxide.

In the case where the surface of the opposite substrate 4 has such groups or substances, it is possible to further improve the bonding strength between the bonding film 3 of the base member 1 and the opposite substrate 4.

By appropriately performing one selected from various surface treatment described above, the surface having such groups and substances can be obtained. This makes it possible to obtain an opposite substrate 4 that can be particularly firmly bonded to the base member 1.

Instead of the surface treatment, a surface layer having a function of improving bonding strength between the opposite substrate 4 and the base member 1 (the bonding film 3) may have been, in advance, provided on the region of the surface of the opposite substrate 4 to which the base member 1 is to be bonded.

In this case, the base member 1 and the opposite substrate 4 are bonded together through such a surface layer of the opposite substrate 4, which makes it possible to obtain a bonded body 5 having higher bonding strength between the base member 1 and the opposite substrate 4.

As a constituent material of such a surface layer, the same material as the constituent material of the above intermediate layer to be provided on the substrate 2 can be used.

Here, description will be made on a mechanism that the base member 1 and the opposite substrate 4 are bonded together in this process. Hereinafter, description will be representatively offered regarding a case that the hydroxyl groups are exposed in the region of the surface of the opposite substrate 4 to which the base member 1 is to be bonded.

In this process, when the base member 1 and the opposite substrate 4 are laminated together so that the bonding film 3 makes contact with the opposite substrate 4, the hydroxyl groups existing on the surface 35 of the bonding film 3 and the hydroxyl groups existing in the region of the surface of the opposite substrate 4 are attracted together, as a result of which hydrogen bonds are generated between the above adjacent hydroxyl groups. It is conceived that the generation of the hydrogen bonds makes it possible to bond the base member 1 and the opposite substrate 4 together.

Depending on conditions such as a temperature and the like, the hydroxyl groups bonded together through the hydrogen bonds are dehydrated and condensed, so that the hydroxyl groups and/or water molecules are removed from the bonding surface (the contact surface) between the base member 1 and the opposite substrate 4. As a result, two atoms, to which the hydroxyl group had been bonded, are bonded together directly or via an oxygen atom. In this way, it is conceived that the base member 1 and the opposite substrate 4 are firmly bonded together.

In this regard, an activated state that the surface 35 of the bonding film 3 is activated in the step [2] is reduced with time. Therefore, it is preferred that this step [3] is started as early as possible after the step [2]. Specifically, this step [3] is preferably started within 60 minutes, and more preferably started within 5 minutes after the step [2].

If the step [3] is started within such a time, since the surface 35 of the bonding film 3 maintains a sufficient activated state, when the base member 1 is bonded to the opposite substrate 4 through the bonding film 3 thereof, they can be bonded together with sufficient high bonding strength therebetween.

In other words, the bonding film 3 before being activated is a film containing the metal atoms and the leaving groups 303 each composed of an organic ingredient, and therefore it has relatively high chemical stability and excellent weather resistance. For this reason, the bonding film 3 before being activated can be stably stored for a long period of time. Therefore, a base member 1 having such a bonding film 3 may be used as follows.

Namely, first, a large number of the base members 1 have been manufactured or purchased, and stored in advance. Then just before the base member 1 makes close contact with the opposite substrate 4 in this step, the energy is applied to only a necessary number of the base members 1 as described in the step [2]. This use is preferable because the bonded bodies 5 are manufactured effectively.

In the manner described above, it is possible to obtain a bonded body (the bonded body of the present invention) 5 shown in FIG. 2D.

In FIG. 2D, the opposite substrate 4 is bonded (attached) to the base member 1 so as to cover the entire surface of the bonding film 3 thereof. However, a relative position of the base member 1 with respect to the opposite substrate 4 may be shifted. In other words, the opposite substrate 4 may be bonded to the base member 1 so as to extend beyond the bonding film 3 thereof.

In the bonded body 5 obtained in this way, bonding strength between the substrate 2 (the base member 1) and the opposite substrate 4 is preferably equal to or larger than 5 MPa (50 kgf/cm²), and more preferably equal to or larger than 10 MPa (100 kgf/cm²). Therefore, peeling of the bonded body 5 having such bonding strength therebetween can be sufficiently prevented.

As described later, in the case where a liquid droplet ejection head is formed using the bonded body 5, it is possible to obtain a liquid droplet ejection head having excellent durability. Further, use of the base member 1 of the present invention makes it possible to efficiently manufacture the bonded body 5 in which the substrate 2 (the base member 1) and the opposite substrate 4 are bonded together by the above large bonding strength therebetween.

In the conventional solid bonding method such as a bonding method of directly bonding silicon substrates, even if surfaces of the silicon substrates to be bonded together are activated, an activated state of each surface can be maintained only for an extremely short period of time (e.g., about several to several tens seconds) in the atmosphere. Therefore, there is a problem in that, after each surface is activated, for example, a time for bonding the two silicon substrates together cannot be sufficiently secured.

On the other hand, according to the present invention, the activated state of the bonding film 3 can be maintained over a relatively long period of time. Therefore, a time for bonding the base member 1 and the opposite substrate 4 can be sufficiently secured, which makes it possible to improve efficiency of bonding them together.

In this regard, it is conceived that the activated state of the bonding film 3 can be maintained over a relatively long period of time, on the grounds that a state generated by removing the leaving groups 303 composed of the organic component from the bonding film 3 is stable.

Just when the bonded body 5 is obtained or after the bonded body 5 has been obtained, if necessary, at least one step (a step of improving bonding strength between the base member 1 and the opposite substrate 4) among three steps (steps [4A], [4B] and [4C]) described below may be applied to the bonded body 5 (a laminated body in which the base member 1 and the opposite substrate 4 are laminated together). This makes it possible to further improve the bonding strength between the base member 1 and the opposite substrate 4.

[4A] In this step, as shown in FIG. 2E, the obtained bonded body 5 is pressed in a direction in which the substrate 2 and the opposite substrate 4 come close to each other.

As a result, surfaces of the bonding film 3 come closer to the surface of the substrate 2 and the surface of the opposite substrate 4. It is possible to further improve the bonding strength between the members in the bonded body 5 (e.g., between the substrate 2 and the bonding film 3, between the bonding film 3 and the opposite substrate 4).

Further, by pressing the bonded body 5, spaces remaining in the boding interfaces (the contact interfaces) in the bonded body 5 can be crashed to further increase a bonding area (a contact area) thereof. This makes it possible to further improve the bonding strength between the members in the bonded body 5.

At this time, it is preferred that a pressure in pressing the bonded body 5 is as high as possible within a range in which the bonded body 5 is not damaged. This makes it possible to improve the bonding strength between the members in the bonded body 5 relative to a degree of this pressure.

In this regard, it is to be noted that this pressure can be appropriately adjusted, depending on the constituent materials and thicknesses of the substrate 2 and opposite substrate 4, conditions of a bonding apparatus, and the like.

Specifically, the pressure is preferably in the range of about 0.2 to 10 MPa, and more preferably in the range of about 1 to 5 MPa, although being slightly different depending on the constituent materials and thicknesses of the substrate 2 and opposite substrate 4, and the like.

By setting the pressure to the above range, it is possible to reliably improve the bonding strength between the members in the bonded body 5. Further, although the pressure may exceed the above upper limit value, there is a fear that damages and the like occur in the substrate 2 and the opposite substrate 4, depending on the constituent materials thereof.

A time for pressing the bonded body 5 is not particularly limited to a specific value, but is preferably in the range of about 10 seconds to 30 minutes. The pressing time can be appropriately changed, depending on the pressure for pressing the bonded body 5. Specifically, in the case where the pressure in pressing the bonded body 5 is higher, it is possible to improve the bonding strength between the members in the bonded body 5 even if the pressing time becomes short.

[4B] In this step, as shown in FIG. 2E, the obtained bonded body 5 is heated.

This makes it possible to further improve the bonding strength between the members in the bonded body 5. A temperature in heating the bonded body 5 is not particularly limited to a specific value, as long as the temperature is higher than room temperature and lower than a heat resistant temperature of the bonded body 5.

Specifically, the temperature is preferably in the range of about 25 to 200° C., and more preferably in the range of about 50 to 100° C. If the bonded body 5 is heated at the temperature of the above range, it is possible to reliably improve the bonding strength between the members in the bonded body 5 while reliably preventing them from being thermally altered and deteriorated.

Further, a heating time is not particularly limited to a specific value, but is preferably in the range of about 1 to 30 minutes.

In the case where both steps [4A] and [4B] are performed, the steps are preferably performed simultaneously. In other words, as shown in FIG. 2E, the bonded body 5 is preferably heated while being pressed. By doing so, an effect by pressing and an effect by heating are exhibited synergistically. It is possible to particularly improve the bonding strength between the members in the bonded body 5.

[4C] In this step, as shown in FIG. 2F, an ultraviolet ray is irradiated on the obtained bonded body 5.

This makes it possible to increase the number of chemical bonds formed between the members in the bonded body 5 (e.g., between the substrate 2 and the bonding film 3, between the bonding film 3 and the opposite substrate 4). As a result, it is possible to improve the bonding strength between the members in the bonded body 5.

Conditions of the ultraviolet ray irradiated at this time can be the same as those of the ultraviolet ray irradiated in the step [2] described above.

Further, in the case where this step [4C] is performed, one of the substrate 2 and the opposite substrate 4 needs to have translucency. It is possible to reliably irradiate the ultraviolet ray on the bonding film 3 by irradiating it from the side of the substrate having translucency.

Through the steps described above, it is possible to easily improve the bonding strength between the members in the bonded body 5 (especially, between the bonding film 3 and the opposite substrate 4), and, eventually, to further improve the bonding strength between the base member 1 and the opposite substrate 4.

Here, as described above, the base member of the present invention has a characteristic in the structure of the bonding film 3. Hereinafter, the bonding film 3 will be described in detail.

As shown in FIGS. 3 and 4, the bonding film 3 contains the metal atoms and the leaving groups 303 each composed of the organic ingredient.

When the energy is applied to such a bonding film 3, the leaving groups 303, which exist at least in the vicinity of the surface 35 of the bonding film 3, are removed therefrom to generate the active hands 304 at least in the vicinity of the surface 35 of the bonding film 3 as shown in FIG. 4. As a result, the surface 35 of the bonding film 3 develops a bonding property.

In the case where the bonding property is developed on the surface 35 of the bonding film 3, the base member 1 can be firmly and efficiently bonded to the opposite substrate 4 with high dimensional accuracy through the bonding film 3 thereof.

Further, since the bonding film 3 includes the metal atoms and the leaving groups 303 each composed of the organic ingredient, that is, the bonding film 3 is formed from an organic metal film, it becomes a strong film which is relatively hardly deformed. Therefore, the bonding film 3 itself has high dimensional accuracy. This also makes it possible to obtain a bonded body 5 having high dimensional accuracy, wherein the bonded body 5 is obtained by bonding the base member 1 to the opposite substrate 4.

Furthermore, such a bonding film 3 is in the form of a solid having no fluidity. Therefore, thickness and shape of a bonding layer (the bonding film 3) are hardly changed as compared to a conventional adhesive layer formed of an aquiform or muciform (semisolid) adhesive having fluidity.

Therefore, dimensional accuracy of the bonded body 5 obtained by bonding the base member 1 and the opposite substrate 4 together becomes extremely high as compared to a conventional bonded body obtained using the adhesive layer (the adhesive). In addition, since it is not necessary to wait until the adhesive is hardened, it is possible to firmly bond the base member 1 to the opposite substrate 4 in a short period of time as compared to the conventional bonded body.

Further, in the present invention, it is preferred that the bonding film 3 has electrical conductivity. As described below, in the case where a wiring board is formed from a bonded body 5 having such a bonding film 3, the bonding film 3 can be used as a wiring, a terminal or the like included in the wiring board.

In the above described bonding film 3, the metal atoms and the leaving groups 303 contained in the bonding film 3 are selected so as to appropriately exhibit the function thereof.

Specifically, examples of the metal atoms include transition metal elements such as Sc, Ti, V, Cr, Mn, Fe, Co, Ni, Cu, Y, Zr, Nb, Mo, Tc, Ru, Rh, Pd, Ag, Hf, Ta, W, Re, Os, Ir, Pt, Au, various kinds of lanthanoid elements and various kinds of actinoid elements, typical metal elements such as Li, Be, Na, Mg, Al, K, Ca, Zn, Ga, Rb, Sr, Cd, In, Sn, Sb, Cs, Ba, Tl, Pd, Bi and Po, and the like.

Here, since a difference between the transition metal elements is only the number of electrons existing in an outermost electron shell thereof, physical properties of the transition metal elements are similar with each other. In general, each transition metal has strong hardness, a high melting point, and excellent electrical and thermal conductivities.

Therefore, in the case where the transition metal elements are used as the metal atoms, it is possible to prevent the metal oxide film from being altered and deteriorated, and to suppress an introduction efficiency of the leaving groups 303 into a surface of the metal oxide film from being reduced in the subsequent step. This makes it possible to further improve a bonding property to be developed in the bonding film 3, and electrical conductivity of the bonding film 3.

Further, in the case where one kind selected from the group comprising Cu, Al, Zn and Fe or two or more kinds selected from the above group are used as the metal atoms, the bonding film 3 can exhibit excellent electrical conductivity. Furthermore, in the case of use of a metal organic chemical vapor deposition method as described below, it is possible to relatively easily form a bonding film 3 having an uniform thickness by using a metal complex containing at least one kind of the above metals or the like as a raw material.

As described above, the active hands 304 are generated in the bonding film 3 due to the removal of the leaving groups 303 therefrom. Therefore, as each of the leaving groups 303, such a group of the type as mentioned below is preferably selected, that is, a group satisfying conditions in that they are relatively easily and uniformly removed from the bonding film 3 when the energy is applied thereto, whereas reliably bonded to the bonding film 3 so as not to be removed therefrom when the energy is not applied.

Specifically, as each of the leaving groups 303, a group composed of an atomic group containing a carbon atom as an essential element, and at least one kind selected from the group comprising a hydrogen atom, a nitrogen atom, a phosphorus atom, a sulfur atom and a halogen atom is preferably selected.

Such leaving groups 303 have excellent properties in bonding to and removing from the bonding film 3 when applying the energy thereto. Therefore, the leaving groups 303 can satisfy the above mentioned conditions sufficiently, which makes it possible to improve a bonding property of the base member 1.

More specifically, examples of the atomic group include: an alkyl group such as a methyl group or an ethyl group; an alkoxy group such as a methoxy group or an ethoxy group; a carboxyl group; the other group such as an alkyl group having an isocyanate group, an amino group or a sulfonic acid group at the end thereof; and the like.

Among the above mentioned atomic groups, the alkyl group is preferably selected as each of the leaving groups 303. Since the leaving groups 303 each constituted from the alkyl group exhibit high chemical stability, the bonding film 3 having the alkyl groups as the leaving groups 303 can have excellent weather resistance and chemical resistance.

Further, in the bonding film 3 having such a structure, an abundance ratio of the metal atoms to the carbon atoms contained in the bonding film 3 is preferably in the range of about 3:7 to 7:3, and more preferably in the range of about 4:6 to 6:4. By setting the abundance ratio of the metal atoms to the carbon atoms to the above range, stability of the bonding film 3 becomes high, and therefore it becomes possible to firmly bond the base member 1 and the opposite substrate 4 together. Further, the bonding film 3 can exhibit excellent electrical conductivity.

Further, an average thickness of the bonding film 3 is preferably in the range of about 1 to 1000 nm, and more preferably in the range of about 50 to 800 nm. By setting the average thickness of the bonding film 3 to the above range, it is possible to prevent dimensional accuracy of the bonded body 5 obtained by bonding the base member 1 and the opposite substrate 4 together from being significantly reduced, thereby enabling to firmly bond them together.

In other words, if the average thickness of the bonding film 3 is lower than the above lower limit value, there is a case that the bonded body 5 having sufficient bonding strength between the base member 1 and the opposite substrate 4 cannot be obtained. In contrast, if the average thickness of the bonding film 3 exceeds the above upper limit value, there is a fear that dimensional accuracy of the bonded body 5 is reduced significantly.

In addition, in the case where the average thickness of the bonding film 3 is set to the above range, even if irregularities exist on a bonding surface (a surface to be adjoined to the bonding film 3) of the substrate 2, the bonding film 3 can be formed so as to assimilate the irregularities of the bonding surface of the substrate 2, though it may be affected depending on sizes (heights) thereof.

As a result, it is possible to suppress sizes of irregularities of the surface 35 of the bonding film 3, which would be generated according to the irregularities of the bonding surface of the substrate 2, from being extremely enlarged. Namely, it is possible to improve flatness of the surface 35 of the bonding film 3. This makes it possible to improve bonding strength between the bonding film 3 and the opposite substrate 4.

In addition, by adjusting the thickness of the bonding film 3 to a specific value, the bonding film 3 can have a certain degree of a shape following property. Therefore, even if the opposite substrate 4 has undulations or irregularities on a surface thereof, the base member 1 can be reliably bonded to the opposite substrate 4 through the deformation of the bonding film 3.

The thicker the thickness of bonding film 3 is, the higher degrees of the above flatness of the surface 35 and shape following property of the bonding film 3 become. Therefore, it is preferred that the thickness of the bonding film 3 is as thick as possible in order to further improve the degrees of the flatness of the surface 35 and the shape following property of the bonding film 3.

The above mentioned bonding film 3 may be formed by any method. Examples of such a method of forming the bonding film 3 include: a method I in which an organic compound containing the leaving groups 303 (an organic component) is applied to almost all of a metal film made of metal atoms; a method II in which an organic compound containing the leaving groups 303 (the organic ingredient) is selectively applied to the vicinity of a surface of a metal film made of metal atoms, that is, the vicinity of the surface of the metal film is chemically modified by the organic compound; a method III in which an organic metal material comprising metal atoms and an organic compound containing the leaving groups 303 as a raw material is formed into a film form using a metal organic chemical vapor deposition method; and the like.

Among the above methods, it is preferred that the bonding film 3 is formed using the method III. Use of the method III makes it possible to form a bonding film 3 having an uniform thickness in a relatively simple step.

Hereinafter, description will be representatively offered regarding a case (that is, the method III) that the bonding film 3 is obtained by forming the organic metal material comprising the metal atoms and the organic compound containing the leaving groups 303 as the raw material into a film form using the metal organic chemical vapor deposition method.

First, prior to description of the method of forming the bonding film 3, description will be made on a film forming apparatus 200 to be used for forming the bonding film 3.

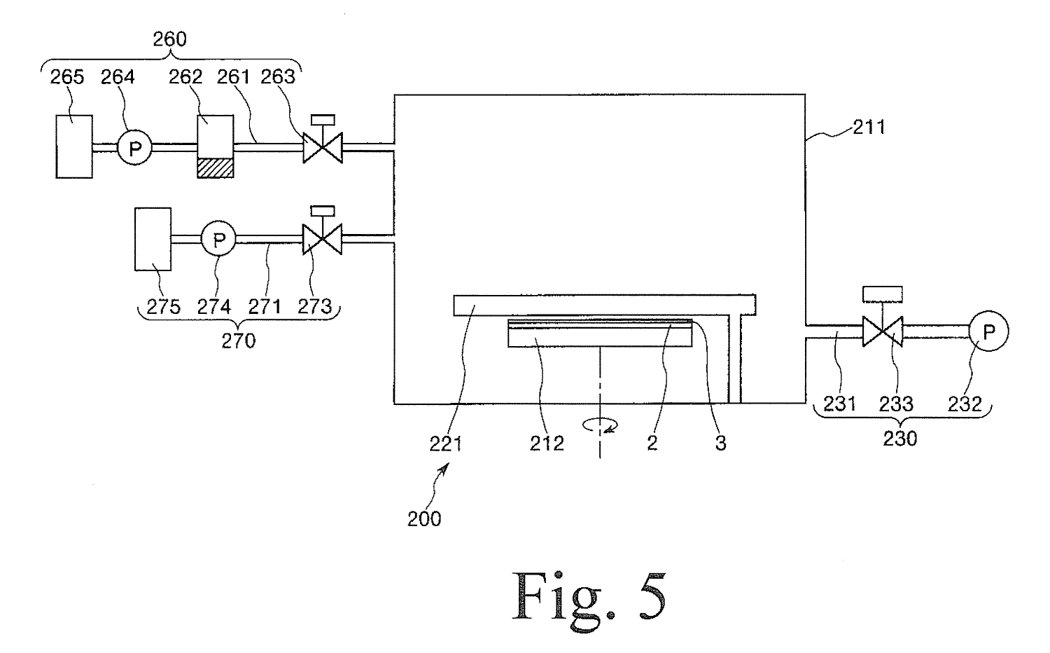

FIG. 5 is a longitudinal sectional view schematically showing a film forming apparatus used for manufacturing the base member according to the present invention.

In this regard, it is to be noted that in the following description, an upper side in FIG. 5 will be referred to as “upper” and a lower side thereof will be referred to as “lower”.

The film forming apparatus 200 shown in FIG. 5 is configured so that the bonding film 3 is formed by the metal organic chemical vapor deposition method (hereinafter, referred to as “a MOCVD method”) in the chamber 211 provided therein.

Specifically, the film forming apparatus 200 includes a chamber (a vacuum chamber) 211, a substrate holder (a film formation object holding unit) 212 that is provided in the chamber 211 and holds the substrate 2 (a film formation object), organic metal material supplying means 260 that supplies a vaporized or atomized organic metal material into the chamber 211, gas supplying means 270 that supplies gas for setting the inside of the chamber 211 to a low reducing atmosphere, evacuating means 230 that evacuates the chamber 211 and controls pressure, and heating means (not shown) that heats the substrate holder 212.

In this embodiment, the substrate holder 212 is attached to a bottom of the chamber 211. The substrate holder 212 is pivotable by actuating a motor. This makes it possible to form a bonding film 3 having homogeneity and an uniform thickness on the substrate 2.

Further, a shutter 221 that can cover the substrate holder 212 is provided near the same. The shutter 221 prevents the substrate 2 and the bonding film 3 from being exposed to an unnecessary atmosphere and the like.

The organic metal material supplying means 260 is connected to the chamber 211. The organic metal material supplying means 260 includes a storage tank 262 that stores a solid organic metal material, a gas bomb 265 that stores a carrier gas for supplying the vaporized or atomized organic metal material into the chamber 211, a gas supply line 261 that leads the carrier gas and the vaporized or atomized organic metal material into the chamber 211, and a pump 264 and a valve 263 provided at a middle of the gas supply line 261.

In the organic metal material supplying means 260 having such a configuration, the storage tank 262 has heating means, and the solid organic metal material can be heated by actuating the heating means so that it is vaporized or atomized. Therefore, when the pump 264 is actuated to supply the carrier gas from the gas bomb 265 to the storage tank 262 in a state that the valve 263 is opened, the vaporized or atomized organic metal material is supplied into the chamber 211 through the supply line 261 together with the carrier gas.

The carrier gas is not particularly limited to a specific kind. As the carrier gas, a nitrogen gas, an argon gas, a helium gas, and the like may be preferably used.

Further, in this embodiment, the gas supplying means 270 is connected to the chamber 211. The gas supplying means 270 includes a gas bomb 275 that stores gas for setting the inside of the chamber 211 to a low reducing atmosphere, a gas supply line 271 that leads the gas into the gas chamber 211, and a pump 274 and a valve 273 provided at a middle of the gas supply line 271.

In the gas supplying means 270 having such a configuration, when the pump 274 is actuated in a state that the valve 273 is opened, the gas for setting the inside of the chamber 211 to the low reducing atmosphere is supplied into the chamber 211 from the gas bomb 275 through the supply line 271. By configuring the gas supplying means 270 as described above, it is possible to reliably set the inside of the chamber 211 to the low reducing atmosphere with respect to the organic metal material.

As a result, in the case where the bonding film 3 is formed from the organic metal material by using the MOCVD method, the bonding film 3 is formed in a state that at least a part of an organic compound contained in the organic metal material remains as the leaving groups 303 (the organic ingredient).

The gas for setting the inside of the chamber 211 to the low reducing atmosphere is not particularly limited to a specific kind. Examples of the gas include a nitrogen gas, rare gas such as helium, argon and xenon, and the like, and any one kind of the above gases may be used singly, or two or more kinds of the above gases may be used in combination.

In the case where a material containing oxygen atoms in a molecule structure such as 2,4-pentadionato copper(II) or [cu(hfac) (VTMS)] described later is used as the organic metal material, a hydrogen gas is preferably added to the gas for setting the inside of the chamber 211 to the low reducing atmosphere. This makes it possible to improve a reducing property with respect to the oxygen atoms and to form the bonding film 3 without remaining excessive oxygen atoms therein. As a result, the bonding film 3 has a low abundance ratio of metal oxide therein so that it can exhibit excellent electrical conductivity.

Further, in the case where at least one kind selected from the group comprising the nitrogen gas, the argon gas and the helium gas described above is used as the carrier gas, the carrier gas also can serve as the gas for setting the inside of the chamber 211 to the low reducing atmosphere.

The evacuating means 230 includes a pump 232, an evacuating line 231 that communicates the pump 232 and the chamber 211 with each other, and a valve 233 provided at a middle of the evacuating line 231. The evacuating means 230 can decompress the inside of the chamber 211 to a desired pressure.

In the film forming apparatus 200 having the configuration described above, the bonding film 3 can be formed on the substrate 2 as described below using the MOCVD method.

[1] First, the substrate 2 is prepared. The substrate 2 is conveyed into the chamber 211 of the film forming apparatus 200 and mounted (set) on the substrate holder 212.

[2] Next, the inside of the chamber 211 is decompressed by opening the valve 233 in a state that the evacuating means 230 is actuated, i.e., the pump 232 is actuated. A degree of the decompression (a degree of vacuum) is not particularly limited to a specific value, but is preferably in the range of about 1×10⁷ to 1×10⁴ Torr, and more preferably in the range of about 1×10⁶ to 1×10⁵ Torr.

Further, the gas for setting the inside of the chamber 211 to the low reducing atmosphere is supplied into the chamber 211 by opening the valve 273 in a state that the gas supplying means 270 is actuated, i.e., the pump 274 is actuated. As a result, the inside of the chamber 211 is set to the low reducing atmosphere.

A flow rate of the gas in the gas supplying means 270 is not particularly limited to a specific value, but is preferably in the range of about 0.1 to 10 sccm, and more preferably in the range of about 0.5 to 5 sccm.

Further, at this time, the heating means is actuated to heat the substrate holder 212. A temperature of the substrate holder 212 is preferably in the range of about 80 to 300° C., and more preferably in the range of 100 to 275° C., although being slightly different depending on kind of the bonding film 3, that is, kind of a raw material to be used for forming the bonding film 3. By setting the temperature to the above range, it is possible to form the bonding film 3 having an excellent bonding property using the organic metal material described later.

[3] Next, the shutter 221 is opened. The solid organic metal material stored in the storage tank 262 is heated by actuating the heating means provided in the storage tank 262 to thereby vaporize or atomize it. In this state, the vaporized or atomized organic metal material is supplied into the chamber 211 together with the carrier gas by actuating the pump 264 and opening the valve 263.

In this way, when the vaporized or atomized organic metal material is supplied into the chamber 211 in a state that the substrate holder 212 is heated in the preceding step <2>, the organic metal material is heated on the substrate 2. This makes it possible to form the bonding film 3 on the substrate 2 so that a part of an organic compound contained in the organic metal material remains therein.

In other words, according to the MOCVD method, it is possible to form a film containing metal atoms so as to remain a part of the organic compound contained in the organic metal material in the film. Therefore, it is possible to obtain a bonding film 3 in which a part of the organic compound (that is, the organic ingredient) serves as the leaving groups 303 therein on the substrate 2.

The organic metal material to be used for such a MOCVD method is not particularly limited to a specific kind. Examples of the organic metal material include: a metal complex such as 2,4-pentadionato copper(II), tris(8-quinolinolato) aluminum (Alq₃), tris(4-methyl-8-quinolinolato) aluminum(III) (Almq₃), (8-hydroxyquinolato) Zinc (Znq₂), copper phthalocyanine, Cu hexafluoroacetylacetonato(vinyltrimethylsilane) (Cu(hfac) (VTMS)), Cu hexafluoroacetylacetonato(2-methyl-1-hexene-3-en) (Cu(hfac)(MHY)), Cu perfluoroacetylacetonato(vinyltrimethylsilane) (Cu(pfac)(VTMS)), or Cu perfluoroacetylacetonato(2-methyl-1-hexene-3-en) (Cu(pfac)(MHY)); alkylmetal such as trimethylgallium, trimethylaluminum or diethyl zinc; derivatives thereof; and the like.

Among these materials, it is preferred that the metal complex is used as the organic metal material. By using the metal complex, it is possible to reliably form a bonding film 3 in which a part of the organic compound contained in the metal complex remains therein.

Further, in this embodiment, the inside of the chamber 211 is set to the low reducing atmosphere by actuating the gas supplying means 270. Setting the inside of the chamber 211 to such an atmosphere makes it possible to effectively prevent or suppress reduction of the organic metal material such as the metal complex.

As a result, it is possible to form a bonding film 3 in which a part of the organic compound contained in the organic metal material remains therein on the substrate 2, which is more advantageous than the structure in which a pure metal film containing no organic compound is directly provided on the substrate 2. In other words, it is possible to form a bonding film 3 having excellent properties of both bonding and metal films.

A flow rate of the vaporized or atomized organic metal material is preferably in the range of about 0.1 to 100 ccm, and more preferably in the range of about 0.5 to 60 ccm. This makes it possible to form a bonding film 3 having an uniform thickness, in which a part of the organic compound contained in the organic metal material remains therein.

As described above, in this embodiment, residue remaining in the bonding film 3 when forming it is used as the leaving groups 303. Therefore, it is unnecessary to form, in advance, a film such as a metal film into which the leaving groups 303 are to be introduced. This makes it possible to form a bonding film 3 in a relatively simple step.

In this regard, it is to be noted that a part of the organic compound remained in the bonding film 3 formed by using the organic metal material may entirely serve as the leaving groups 303 or may partially serve as the leaving groups 303.

As described above, the bonding film 3 is formed on the substrate 2 so that the base member 1 can be obtained.

### Second Embodiment

Next, description will be made on a second embodiment of each of the base member of the present invention, a bonding method of bonding the base member and an opposite substrate together, that is, the bonding method of the present invention, and the bonded body of the present invention including the above base member.

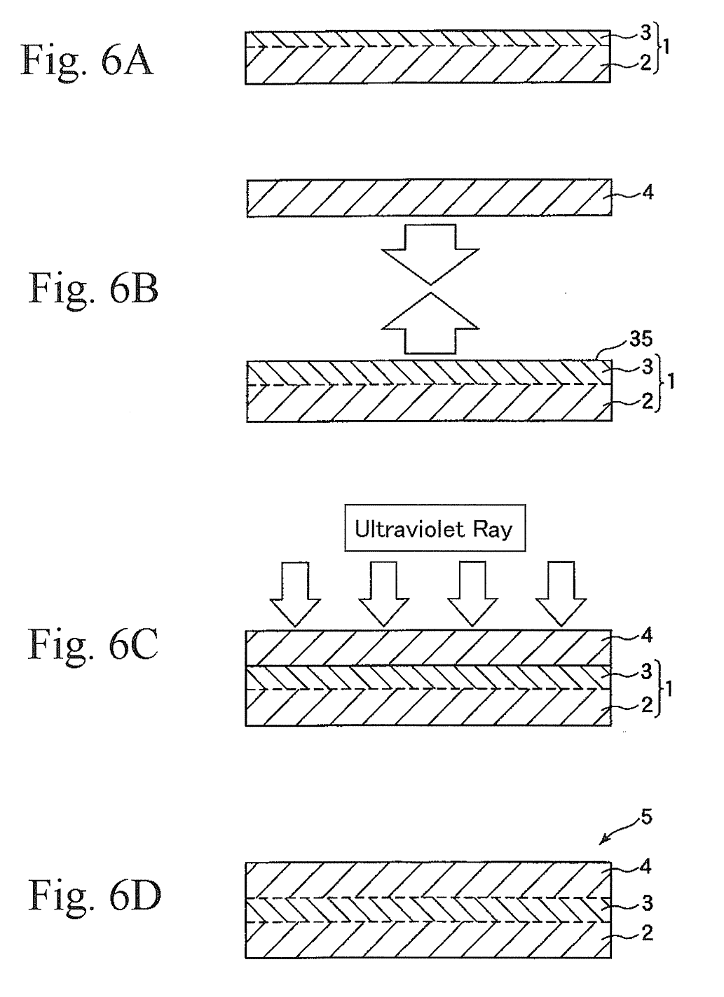

FIGS. 6A to 6D are longitudinal sectional views for explaining a second embodiment of the bonding method of bonding the base member according to the present invention to an opposite substrate (an object).

In this regard, it is to be noted that in the following description, an upper side in each of FIGS. 6A to 6D will be referred to as “upper” and a lower side thereof will be referred to as “lower”.

Hereinafter, the bonding method according to the second embodiment will be described by placing emphasis on the points differing from the first embodiment, with the same matters omitted from description.

The bonding method according to this embodiment is the same as that of the first embodiment, except that after the base member 1 and the opposite substrate 4 are laminated together, the energy is applied to the bonding film 3.

In other words, the bonding method according to this embodiment includes a step of preparing the base member 1 of the present invention and the opposite substrate (the object) 4, a step of making the prepared opposite substrate 4 and the base member 1 close contact with each other through the bonding film 3 to obtain a laminated body in which they are laminated together, and a step of applying the energy to the bonding film 3 in the laminated body so that it is activated and the base member 1 and the opposite substrate 4 are bonded together, to thereby obtain a bonded body 5.

Hereinafter, the respective steps of the bonding method according to this embodiment will be described one after another.

[1] First, the base member 1 is prepared in the same manner as in the first embodiment (see FIG. 6A).

[2] Next, as shown in FIG. 6B, the opposite substrate 4 is prepared. Thereafter, the base member 1 and the opposite substrate 4 are laminated together so that the surface 35 of the bonding film 3 thereof and the opposite substrate 4 make close contact with each other, to obtain the laminated body.

In the state of the laminated body, the base member 1 and the opposite substrate 4 are not bonded together. Therefore, it is possible to adjust a relative position of the base member 1 with respect to the opposite substrate 4.

This makes it possible to finely adjust the relative position of the base member 1 with relative to the opposite substrate 4 easily after they have been laminated (overlapped) together. As a result, it becomes possible to increase positional accuracy of the base member 1 with relative to the opposite substrate 4 in a direction of the surface 35 of the bonding film 3.

[3] Then, as shown in FIG. 6C, the energy is applied to the bonding film 3 in the laminated body. When the energy is applied on the surface 35 of the bonding film 3 which makes contact with the opposite substrate 4, a bonding property with respect to the opposite substrate 4 is developed on the surface 35.

As a result, the base member 1 and the opposite substrate 4 are bonded together due to the bonding property developed on the surface 35, to thereby obtain a bonded body 5 as shown in FIG. 6D. In this regard, it is to be noted that the energy may be applied to the bonding film 3 by any method including, e.g., the methods described in the first embodiment.

In this embodiment, it is preferred that at least one method selected from the group comprising a method in which an energy beam is irradiated on the bonding film 3, a method in which the bonding film 3 is heated, and a method in which a compressive force (physical energy) is applied to the bonding film 3 is used as the method of applying the energy to the bonding film 3.

The reason why these methods are preferred as the energy application method is that they are capable of relatively easily and efficiently applying the energy to the bonding film 3. Among these methods, the same method as employed in the first embodiment can be used as the method in which the energy beam is irradiated on the bonding film 3.

In this case, the energy beam is transmitted through the substrate 2 and is irradiated on the bonding film 3, or the energy beam is transmitted through the opposite substrate 4 and is irradiated on the bonding film 3. For this reason, between the substrate 2 and the opposite substrate 4, the substrate on which the energy beam is irradiated has transparency.

On the other hand, in the case where the energy is applied to the bonding film 3 by heating the bonding film 3, a heating temperature is preferably in the range of about 25 to 200° C., and more preferably in the range of about 50 to 100° C. If the bonding film 3 is heated at a temperature of the above range, it is possible to reliably activate the bonding film 3 while reliably preventing the substrate 2 and the opposite substrate 4 from being thermally altered or deteriorated.

Further, a heating time is set great enough to remove the leaving groups 303 included in the bonding film 3. Specifically, the heating temperature may be preferably in the range of about 1 to 30 minutes if the heating temperature is set to the above mentioned range. Furthermore, the bonding film 3 may be heated by any method. Examples of the heating method include various kinds of methods such as a method using a heater, a method of irradiating an infrared ray and a method of making contact with a flame.

In the case of using the method of irradiating the infrared ray, it is preferred that the substrate 2 or the opposite substrate 4 is made of a light-absorbing material. This ensures that the substrate 2 or the opposite substrate 4 can generate heat efficiently when the infrared ray is irradiated thereon. As a result, it is possible to efficiently heat the bonding film 3.

Further, in the case of using the method using the heater or the method of making contact with the flame, it is preferred that, between the substrate 2 and the opposite substrate 4, the substrate with which the heater or the flame makes contact is made of a material that exhibits superior thermal conductivity. This makes it possible to efficiently transfer the heat to the bonding film 3 through the substrate 2 or the opposite substrate 4, thereby efficiently heating the bonding film 3.

Furthermore, in the case where the energy is applied to the bonding film 3 by imparting the compressive force to the bonding film 3, it is preferred that the base member 1 and the opposite substrate 4 are compressed against each other. Specifically, a pressure in compressing them is preferably in the range of about 0.2 to 10 MPa, and more preferably in the range of about 1 to 5 MPa.

This makes it possible to easily apply appropriate energy to the bonding film 3 by merely performing a compressing operation, which ensures that a sufficiently high bonding property with respect to the opposite substrate 4 is developed in the bonding film 3. Although the pressure may exceed the above upper limit value, it is likely that damages and the like occur in the substrate 2 and the opposite substrate 4, depending on the constituent materials thereof.

Further, a compressing time is not particularly limited to a specific value, but is preferably in the range of about 10 seconds to 30 minutes. In this regard, it is to be noted that the compressing time can be suitably changed, depending on magnitude of the compressive force. Specifically, the compressing time can be shortened as the compressive force becomes greater.

In the manner described above, it is possible to obtain a bonded body 5 in which the base member 1 is bonded to the opposite substrate 4 through the bonding film 3 thereof.

### Third Embodiment

Next, description will be made on a third embodiment of each of the base member of the present invention, a bonding method of bonding the base member and an opposite substrate together, that is, the bonding method of the present invention, and the bonded body of the present invention including the above base member.

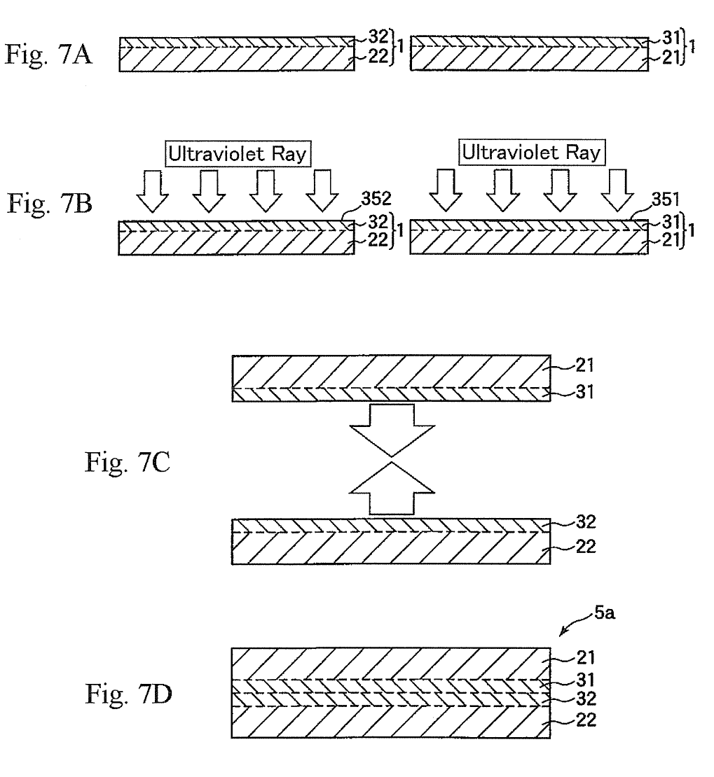

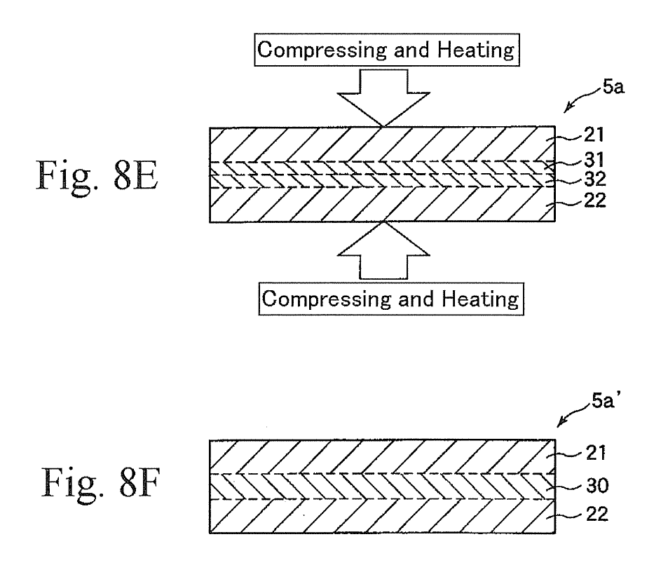

FIGS. 7A to 7D, 8E and 8F are longitudinal sectional views for explaining a third embodiment of the bonding method of bonding the base member according to the present invention to an opposite substrate (an object).

In this regard, it is to be noted that in the following description, an upper side in each of FIGS. 7A to 7D, 8E and 8F will be referred to as “upper” and a lower side thereof will be referred to as “lower”.

Hereinafter, the bonding method according to the third embodiment will be described by placing emphasis on the points differing from the first and second embodiments, with the same matters omitted from description.

The bonding method according to this embodiment is the same as that of the first embodiment, except that two base members 1 (that is, a first base member 1 and a second base member 1) are bonded together.

In other words, the bonding method according to this embodiment includes a step of preparing two base members 1 each having a bonding film 31 or a bonding film 32, a step of applying the energy to the bonding films 31 and 32 of the base members 1 so that they are activated, and a step of making the two base members 1 close contact with each other through the bonding films 31 and 32 so that they are bonded together, to thereby obtain a bonded body 5a.

Hereinafter, the respective steps of the bonding method according to this embodiment will be described one after another.

[1] First, two base members 1 are prepared in the same manner as in the first embodiment (see FIG. 7A).

In this embodiment, as shown in FIG. 7A, as the two base members 1, used are a base member (a first base member) 1 having a substrate 21 and a bonding film 31 provided on the substrate 21, and a base member (a second base member) 1 having a substrate 22 and a bonding film 32 provided on the substrate 22.

[2] Next, as shown in FIG. 7B, the energy is applied to the bonding films 31 and 32 of the two base members 1.

When the energy is applied to the bonding films 31 and 32, respectively, at least a part of the leaving groups 303 illustrated in FIG. 3 are removed therefrom. After the leaving groups 303 have been removed, the active hands 304 are generated in the vicinity of the surfaces 35 of the bonding films 31 and 32 as shown in FIG. 4.

In this state, the bonding films 31 and 32 are activated, that is, a bonding property is developed in the bonding films 31 and 32. The two base members 1 each having the above state are rendered bondable to each other. In this regard, it is to be noted that the same method as employed in the first embodiment can be used as the energy application method.

Here, a state that the bonding films 31 and 32 are “activated” means: a state that the leaving groups 303 existing on surfaces 351 and 352 and in the inside of the bonding films 31 and 32 are removed as described above in connection with the first embodiment, and atoms constituting the bonding film 3, from which the leaving groups 303 are removed (left), are not terminated so that “dangling bonds (or uncoupled bonds)” are generated; a state that the atoms having the dangling bonds (the unpaired electrons) are terminated by hydroxyl groups (OH groups) so that the hydroxyl groups exist on the surfaces 351 and 352 of the bonding films 31 and 32; and a state that the dangling bonds and the hydroxyl groups coexist on the surfaces 351 and 352 of the bonding films 31 and 32.

Therefore, in this specification, as shown in FIG. 4, the active hands 304 refer to the dangling bonds and/or the hydroxyl groups bonded to the atoms which have had the dangling bonds.

[3] Then, as shown in FIG. 7C, the two base members 1 are laminated together so that the bonding films 31 and 32 each having the bonding property thus developed make close contact with each other, to thereby obtain a bonded body 5a. In this step, the two base members 1 are bonded together. It is conceived that this bonding results from one or both of the following mechanisms (i) and (ii).

Hereinafter, description will be representatively offered regarding a case that hydroxyl groups are exposed on the surfaces 351 and 352 of the bonding films 31 and 32.

(i) When the two base members 1 are laminated together so that the bonding films 31 and 32 make close contact with each other, the hydroxyl groups existing on the surfaces 351 and 352 of the bonding films 31 and 32 thereof are attracted together, as a result of which hydrogen bonds are generated between the above adjacent hydroxyl groups. It is conceived that the generation of the hydrogen bonds makes it possible to bond the two base members 1 together.

Depending on conditions such as a temperature and the like, the hydroxyl groups bonded together through the hydrogen bonds are dehydrated and condensed, so that the hydroxyl groups and/or water molecules are removed from the bonding surface (the contact surface) between the two base members 1. As a result, two atoms, to which the hydroxyl groups had been bonded, are bonded together directly or via an oxygen atom. In this way, it is conceived that the base members 1 are firmly bonded together.

(ii) When the two base members 1 are laminated together, the dangling bonds (the uncoupled bonds) generated in the vicinity of the surfaces 351 and 352 of the bonding films 31 and 32 are bonded together. This bonding occurs in a complicated fashion so that the dangling bonds are inter-linked.

As a result, network-like bonds are formed in the bonding interface between the base members 1. This ensures that either the metal or oxygen atoms constituting the bonding films 31 and 32 are directly bonded together, as a result of which the respective bonding films 31 and 32 are united (bonded) together.

By the above mechanism (i) and/or mechanism (ii), it is possible to obtain the bonded body 5a as shown in FIG. 7D.

If necessary, the bonded body 5a thus obtained may be subjected to at least one of the steps [4A], [4B] and [4C] in the first embodiment.

For example, if the bonded body 5a is heated while compressing the same as shown in FIG. 8E, the substrates 21 and 22 in the bonded body 5a come closer to each other. This accelerates dehydration and condensation of the hydroxyl groups and/or bonding of the dangling bonds in the interface between the bonding films 31 and 32. Thus, unification (bonding) of the bonding films 31 and 32 is further progressed. As a result, as shown in FIG. 8F, it is possible to obtain a bonded body 5a′ having a substantially completely united bonding film.

### Fourth Embodiment

Next, description will be made on a fourth embodiment of each of the base member of the present invention, a bonding method of bonding the base member and an opposite substrate together, that is, the bonding method of the present invention, and the bonded body of the present invention including the above base member.

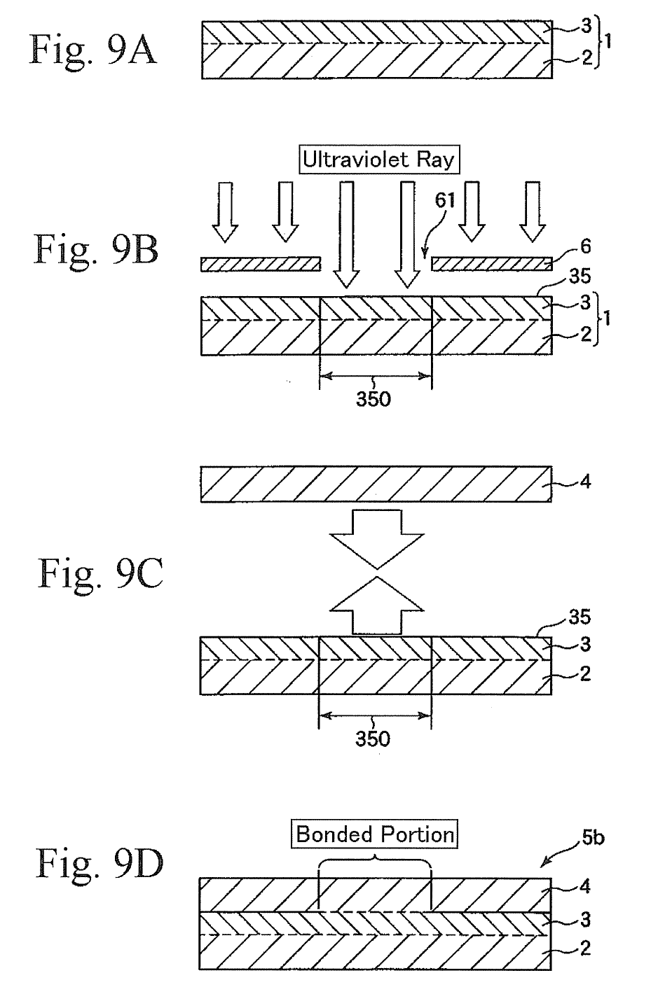

FIGS. 9A to 9D are longitudinal sectional views for explaining a fourth embodiment of the bonding method of bonding the base member according to the present invention to an opposite substrate (an object).

In this regard, it is to be noted that in the following description, an upper side in each of FIGS. 9A to 9D will be referred to as “upper” and a lower side thereof will be referred to as “lower”.

Hereinafter, the bonding method according to the fourth embodiment will be described by placing emphasis on the points differing from the first to third embodiments, with the same matters omitted from description.

The bonding method according to this embodiment is the same as that of the first embodiment, except that only a predetermined region 350 of the bonding film 3 is selectively activated, and the base member 1 and the opposite substrate 4 are partially bonded together in the predetermined region 350.

In other words, the bonding method according to this embodiment includes a step of preparing the base member 1 of the present invention and the opposite substrate (the object) 4, a step of applying the energy to the predetermined region 350 of the bonding film 3 of the base member 1 so that it is selectively activated, and a step of making the prepared opposite substrate 4 and the base member 1 contact with each other through the bonding film 3 so that they are partially bonded together in the predetermined region 350, to thereby obtain a bonded body 5b.

Hereinafter, the respective steps of the bonding method according to this embodiment will be described one after another.

[1] First, the base member 1 (the base member of the present invention) is prepared (see FIG. 9A).

[2] Next, as shown in FIG. 9B, the energy is selectively applied to the predetermined region 350 of the surface 35 of the bonding film 3 of the base member 1.

When the energy is applied to the predetermined region 350 of the bonding film 3, at least a part of the leaving groups 303 shown in FIG. 3 are removed therefrom. After the leaving groups 303 have been removed, the active hands 304 are generated in the vicinity of the surface 35 of the bonding film 3 in the predetermined region 350 as shown in FIG. 4.

In this state, the bonding film 3 is activated, that is, a bonding property with respect to the opposite substrate 4 is developed in the predetermined region 350 of the bonding film 3. In contrast, little or no bonding property is developed in a region of the bonding film 3 other than the predetermined region 350.

The base member 1 having the above state is rendered partially bondable to the opposite substrate 4 in the predetermined region 350. In this regard, it is to be noted that the energy may be applied to the bonding film 3 by any method including, e.g., the methods described in the first embodiment.

In this embodiment, it is particularly preferred that a method of irradiating an energy beam on the bonding film 3 is used as the energy application method. The reason why this method is preferred as the energy application method is that it is capable of relatively easily and efficiently applying the energy to the bonding film 3.

Further, in this embodiment, it is preferred that energy beams having high directionality such as a laser beam and an electron beam are used as the energy beam. Use of these energy beams makes it possible to selectively and easily irradiate the energy beam on a predetermined region 350 by irradiating it in a target direction.

Even in the case where an energy beam with low directionality is used, it is possible to selectively irradiate the energy beam on the predetermined region 350 of the surface 35 of the bonding film 3, if radiation thereof is performed by covering (shielding) a region other than the predetermined region 350 to which the energy beam is to be irradiated.

Specifically, as shown in FIG. 9B, a mask 6 having a window portion 61 whose shape corresponds to a shape of the predetermined region 350 may be provided above the surface 35 of the bonding film 3. Then, the energy beam may be irradiated through the mask 6. By doing so, it is easy to selectively irradiate the energy beam on the predetermined region 350.

[3] Next, the opposite substrate (the object) 4 is prepared as shown in FIG. 9C. Then, the base member 1 and the opposite substrate 4 are laminated together so that the bonding film 3 having the selectively activated predetermined region 350 makes close contact with the opposite substrate 4. This makes it possible to obtain a bonded body 5b shown in FIG. 9D.

In the bonded body 5b thus obtained, the base member 1 and the opposite substrate 4 are not bonded together in the entire of an interface therebetween, but partially bonded together only in a partial region (the predetermined region 350). During this bonding operation, it is possible to readily select a bonded region by merely controlling an energy application region of the bonding film 3.

This makes it possible to control, e.g., an area of the activated region (the predetermined region 350 in this embodiment) of the bonding film 3 of the base member 1, which in turn makes it possible to easily adjust the bonding strength between the base member 1 and the opposite substrate 4. As a result, there is provided a bonded body 5b that allows a bonded portion to be separated easily.

Further, it is also possible to reduce local concentration of stress which would be generated in the bonded portion by suitably controlling an area and shape of the bonded portion (the predetermined region 350) of the base member 1 and the opposite substrate 4 shown in FIG. 9D.

This makes it possible to reliably bond the base member 1 and the opposite substrate 4 together, e.g., even in the case where the substrate 2 and the opposite substrate 4 exhibit a large difference in their thermal expansion coefficients.

In addition, in the bonded body 5b, a tiny gap is generated (or remains) between the base member 1 and the opposite substrate 4 in the region other than the predetermined bonding region 350. This means that it is possible to easily form closed spaces, flow paths or the like between the base member 1 and the opposite substrate 4 by suitably changing the shape of the predetermined region 350.

As described above, it is possible to adjust the bonding strength between the base member 1 and the opposite substrate 4 and separating strength (splitting strength) therebetween by controlling the area of the bonded portion (the predetermined region 350) between the base member 1 and the opposite substrate 4.

From this standpoint, it is preferred that, in the case of producing an easy-to-separate bonded body 5b, the bonding strength between the base member 1 and the opposite substrate 4 is set enough for the human hands to separate the bonded body 5b. By doing so, it becomes possible to easily separate the bonded body 5b without having to use any device or tool.

In the manner described above, it is possible to obtain the bonded body 5b.

If necessary, the bonded body 5b thus obtained may be subjected to at least one of the steps [4A], [4B] and [4C] in the first embodiment.

At this time, the tiny gap is generated (or remains) in the region (a non-bonding region), other than the predetermined region 350, of the interface between the bonding film 3 and the opposite substrate 4 in the bonded body 5b. Therefore, it is preferred that the compressing and heating of the bonded body 5b is performed under the conditions in that the bonding film 3 and the opposite substrate 4 are not bonded together in the region other than the predetermined region 350.

Taking the above situations into account, it is preferred that the predetermined region 350 is preferentially subjected to at least one of the steps [4A], [4B] and [4C] in the first embodiment, when such a need arises. This makes it possible to prevent the bonding film 3 and the opposite substrate 4 from being bonded together in the region other than the predetermined region 350.

### Fifth Embodiment

Next, description will be made on a fifth embodiment of each of the base member of the present invention, a bonding method of bonding the base member and an opposite substrate together, that is, the bonding method of the present invention, and the bonded body of the present invention including the above base member.

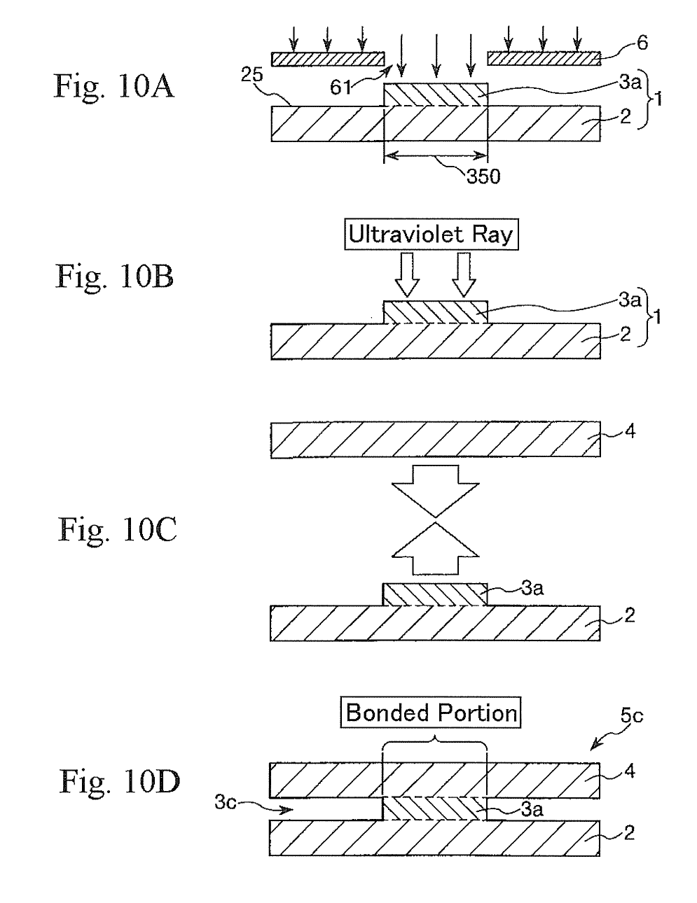

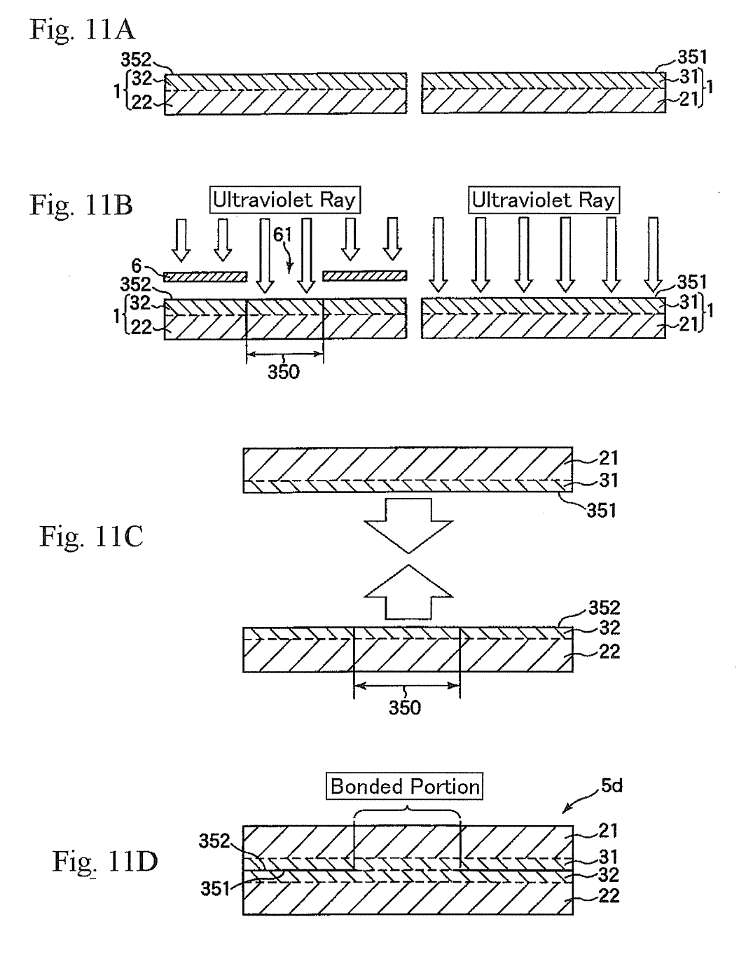

FIGS. 10A to 10D are longitudinal sectional views for explaining a fifth embodiment of the bonding method of bonding the base member according to the present invention to an opposite substrate (an object).

In this regard, it is to be noted that in the following description, an upper side in each of FIGS. 10A to 10D will be referred to as “upper” and a lower side thereof will be referred to as “lower”.

Hereinafter, the bonding method according to the fifth embodiment will be described by placing emphasis on the points differing from the first to fourth embodiments, with the same matters omitted from description.

The bonding method according to this embodiment is the same as that of the first embodiment, except that a base member 1 is obtained by selectively forming a bonding film 3a only in a predetermined region 350 of an upper surface 25 of the substrate 2, and the base member 1 and the opposite substrate 4 are partially bonded together in the predetermined region 350.

In other words, the bonding method according to this embodiment includes a step of preparing the base member 1 having the bonding film 3a and the opposite substrate (the object) 4, a step of applying the energy to the bonding film 3a of the base member 1 so that it is activated, and a step of making the prepared opposite substrate 4 and the base member 1 contact with each other through the bonding film 3a so that they are bonded together through the bonding film 3a, to thereby obtain a bonded body 5c.

Hereinafter, the respective steps of the bonding method according to this embodiment will be described one after another.

[1] First, as shown in FIG. 10A, a mask 6 having a window portion 61 whose shape corresponds to a shape of the predetermined region 350 is provided above the substrate 2.

Then, the bonding film 3a is formed on the upper surface 25 of the substrate 2 through the mask 6. As shown in FIG. 10A, in the case where a plasma polymerization method is used as the method of forming the bonding film 3a, by applying a polymerized matter produced by the plasma polymerization method onto the surface 25 of the substrate 2 through the mask 6, the polymerized matter is selectively deposited on the predetermined region 350 to thereby form the bonding film 3a thereon.

[2] Next, the energy is applied to the bonding film 3a as shown in FIG. 10B. By doing so, a bonding property with respect to the opposite substrate 4 is developed in the bonding film 3a of the base member 1.

During the application of the energy in this step, the energy may be applied selectively to the bonding film 3a or to the entirety of the upper surface 25 of the substrate 2 including the bonding film 3a. Further, the energy may be applied to the bonding film 3a by any method including, e.g., the methods described in the first embodiment.

[3] Next, the opposite substrate (the object) 4 is prepared as shown in FIG. 10C. Then, the base member 1 and the opposite substrate 4 are laminated together so that the bonding film 3a and the opposite substrate 4 make close contact with each other. This makes it possible to obtain a bonded body 5c as shown in FIG. 10D.

In the bonded body 5c thus obtained, the substrate 2 and the opposite substrate 4 are not bonded together in the entire of an interface therebetween, but partially bonded together only in a partial region (the predetermined region 350). During the formation of the bonding film 3a, it is possible to easily select a bonded region by merely controlling the film formation region.

This makes it possible to control, e.g., an area of the region (the predetermined region 350) in which the bonding film 3a is formed, which in turn makes it possible to easily adjust the bonding strength between the base member 1 and the opposite substrate 4. As a result, there is provided a bonded body 5c that allows a bonded portion to be separated easily.

Further, it is possible to reduce local concentration of stress which would be generated in the bonded portion by suitably controlling an area and shape of the bonded portion (the predetermined region 350) of the base member 1 and the opposite substrate 4 shown in FIG. 10D.

This makes it possible to reliably bond the base member 1 and the opposite substrate 4 together, e.g., even in the case where the substrate 2 and the opposite substrate 4 exhibit a large difference in their thermal expansion coefficients.

In addition, between the substrate 2 and the opposite substrate 4 in the bonded body 5c, a gap 3c having a size corresponding to the thickness of the bonding film 3a is formed in the region other than the predetermined region 350 (see FIG. 10D).

This means that it is possible to easily form closed spaces, flow paths or the like each having a desired shape between the substrate 2 and the opposite substrate 4 by suitably changing the shape of the predetermined region 350 and the thickness of the bonding film 3a.

In the manner described above, it is possible to obtain the bonded body 5c.

If necessary, the bonded body 5c thus obtained may be subjected to at least one of the steps [4A], [4B] and [4C] in the first embodiment.

### Sixth Embodiment

Next, description will be made on a sixth embodiment of each of the base member of the present invention, a bonding method of bonding the base member and an opposite substrate together, that is, the bonding method of the present invention, and the bonded body of the present invention including the above base member.

FIGS. 11A to 11D are longitudinal sectional views for explaining a sixth embodiment of the bonding method of bonding the base member according to the present invention to an opposite substrate (an object).

In this regard, it is to be noted that in the following description, an upper side in each of FIGS. 11A to 11D will be referred to as “upper” and a lower side thereof will be referred to as “lower”.

Hereinafter, the bonding method according to the sixth embodiment will be described by placing emphasis on the points differing from the first to fifth embodiments, with the same matters omitted from description.

The bonding method according to this embodiment is the same as that of the first embodiment, except that two base members 1 each having a bonding film 31 or a bonding film 32 are prepared, the bonding film 31 and only a predetermined region 350 of the bonding film 32 thereof are activated, and the two base members 1 are bonded together in the predetermined region 350.

In other words, the bonding method according to this embodiment includes a step of preparing the two base members 1 each having the bonding film 31 or the bonding film 32, a step of applying the energy to different regions (the entire of the surface 351 and the predetermined region 350 of the surface 352) of the bonding films 31 and 32 of the two base members 1 so that the different regions are activated, and a step of making the base members 1 contact with each other through the bonding films 31 and 32 so that they are partially bonded together in the predetermined region 350, to thereby obtain a bonded body 5d.

Hereinafter, the respective steps of the bonding method according to this embodiment will be described one after another.

[1] First, two base members 1 are prepared in the same manner as in the first embodiment (see FIG. 11A).

In this embodiment, as shown in FIG. 11A, as the two base members 1, used are a base member (a first base member) 1 having a substrate 21 and a bonding film 31 provided on the substrate 21, and a base member (a second base member) 1 having a substrate 22 and a bonding film 32 provided on the substrate 22.

[2] Next, as shown in FIG. 11B, the energy is applied to the entirety of the surface 351 of the bonding film 31 of one of the two base members 1. By doing so, a bonding property is developed over the entirety of the surface 351 of the bonding film 31.

On the other hand, the energy is selectively applied to the predetermined region 350 of the surface 352 of the bonding film 32 of the other base member 1. The same method as employed in the fourth embodiment may be used as the method of selectively applying the energy to the predetermined region 350.

When the energy is applied to the bonding films 31 and 32, respectively, at least a part of the leaving groups 303 shown in FIG. 3 are removed therefrom. After the leaving groups 303 have been removed, the active hands 304 are generated in the vicinity of the surfaces 351 and 352 of the bonding films 31 and 32 as shown in FIG. 4.

In this state, the bonding films 31 and 32 are activated, that is, a bonding property is developed in the entirety of the surface 351 of the bonding film 31 and in the predetermined region 350 of the surface 352 of the bonding film 32, respectively.

In contrast, little or no bonding property is developed in a region of the bonding film 32 other than the predetermined region 350. The two base members 1 each having the above state are rendered partially bondable to each other in the predetermined region 350.

[3] Then, as shown in FIG. 11C, the two base members 1 are laminated together so that the bonding films 31 and 32 each having the bonding property thus developed make close contact with each other, to thereby obtain a bonded body 5d as shown in FIG. 11D.

In the bonded body 5d thus obtained, the two base members 1 are not bonded together in the entire of an interface therebetween, but partially bonded together only in a partial region (the predetermined region 350). During this bonding operation, it is possible to easily select a bonded region by merely controlling an energy application region of the bonding film 32. This makes it possible to easily control, e.g., the bonding strength between the base members 1.

In the manner described above, it is possible to obtain the bonded body 5d.

If necessary, the bonded body 5d thus obtained may be subjected to at least one of the steps [4A], [4B] and [4C] in the first embodiment.

For example, if the bonded body 5d is heated while compressing the same, the substrates 21 and 22 in the bonded body 5d come closer to each other. This accelerates dehydration and condensation of the hydroxyl groups and/or bonding of the dangling bonds in the interface between the bonding films 31 and 32. Thus, unification (bonding) of the bonding films 31 and 32 is further progressed in the bonded portion formed in the predetermined region 350. Eventually, the bonding films 31 and 32 are substantially completely united.

At this time, a tiny gap is generated (or remains) in the region (a non-bonding region), other than the predetermined region 350, of the interface between the surfaces 351 and 352 of the bonding films 31 and 32. Therefore, it is preferred that the compressing and heating of the bonded body 5d is performed under the conditions in that the bonding films 31 and 32 are not bonded together in the region other than the predetermined region 350.

Taking the above situations into account, it is preferred that the predetermined region 350 is preferentially subjected to at least one of the steps [4A], [4B] and [4C] in the first embodiment, when such a need arises. This makes it possible to prevent the bonding films 31 and 32 from being bonded together in the region other than the predetermined region 350.

### Seventh Embodiment

Next, description will be made on a seventh embodiment of each of the base member of the present invention, a bonding method of bonding the base member and an opposite substrate together, that is, the bonding method of the present invention, and the bonded body of the present invention including the above base member.

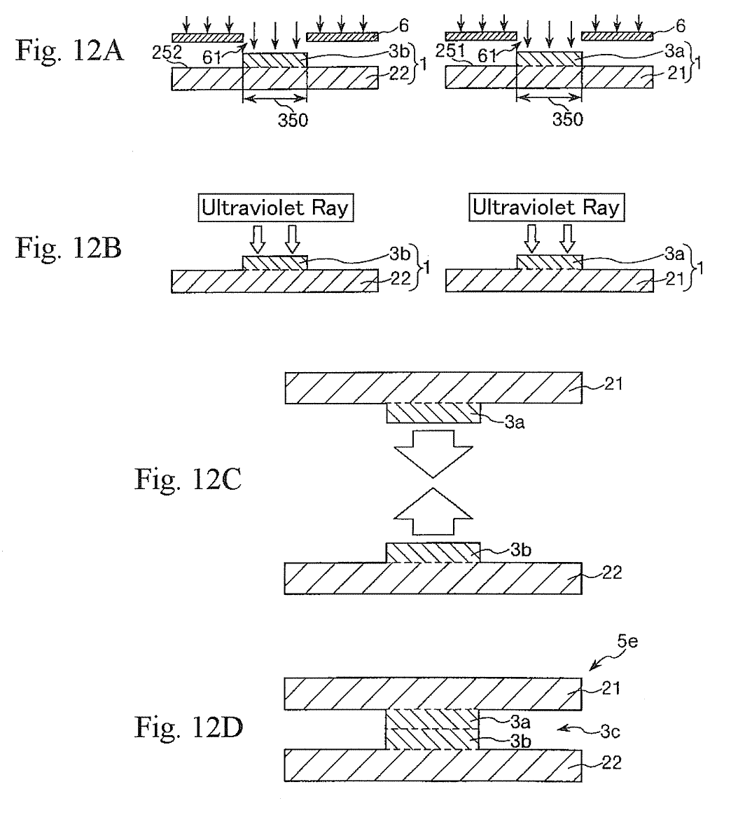

FIGS. 12A to 12D are longitudinal sectional views for explaining a seventh embodiment of the bonding method of bonding the base member according to the present invention to an opposite substrate (an object).

In this regard, it is to be noted that in the following description, an upper side in each of FIGS. 12A to 12D will be referred to as “upper” and a lower side thereof will be referred to as “lower”.

Hereinafter, the bonding method according to the seventh embodiment will be described by placing emphasis on the points differing from the first to sixth embodiments, with the same matters omitted from description.

The bonding method according to this embodiment is the same as that of the first embodiment, except that two base members 1 are obtained by selectively forming bonding films 3a and 3b only in predetermined regions 350 of upper surfaces 251 and 252 of substrates 21 and 22, and the two base members 1 are partially bonded together through the bonding films 3a and 3b thereof.

In other words, the bonding method according to this embodiment includes a step of preparing two base members 1 each having the substrate 21 or 22 and the bonding film 3a or 3b formed in a predetermined region 350 of the substrates 21 or 22, a step of applying the energy to the bonding films 3a and 3b of the base members 1 so that they are activated, and a step of making the two base members 1 close contact with each other through the bonding films 3a and 3b so that they are partially bonded together, to thereby obtain a bonded body 5e.

Hereinafter, the respective steps of the bonding method according to this embodiment will be described one after another.

[1] First, as shown in FIG. 12A, masks 6 each having a window 61 whose shape corresponds to a shape of the predetermined region 350 are respectively provided above the substrates 21 and 22.

Then, the bonding films 3a and 3b are respectively formed on the upper surfaces 251 and 252 of the substrates 21 and 22 through the masks 6. As shown in FIG. 12A, in the case where a MOCVD method is used as the method of forming the bonding films 3a and 3b, by applying an organic metal material onto the surfaces 251 and 252 of the substrates 21 and 22 through the masks 6, the organic metal material is selectively deposited on the predetermined regions 350 in a state that a part of the organic compound contained therein remains in the bonding films 3a and 3b. As a result, it is possible to form the bonding films 3a and 3b on the predetermined regions 350 of the substrates 21 and 22, respectively.

[2] Next, as shown in FIG. 12B, the energy is applied to the bonding films 3a and 3b, respectively. By doing so, a bonding property is developed in each of the bonding films 3a and 3b of the base members 1.

During the application of the energy in this step, the energy may be applied selectively to the bonding films 3a and 3b or to the entirety of the upper surfaces 251 and 252 of the substrates 21 and 22 including the bonding films 3a and 3b. In this regard, it is to be noted that the energy may be applied to the bonding films 3a and 3b by any method including, e.g., the methods described in the first embodiment.

[3] Next, as shown in FIG. 12C, the two base members 1 are laminated together so that the bonding films 3a and 3b each having the bonding property thus developed make close contact with each other. This makes it possible to obtain a bonded body 5e as shown in FIG. 12D.

In the bonded body 5e thus obtained, the two base members 1 are not bonded together in the entire of an interface therebetween, but partially bonded together only in a partial region (the predetermined region 350). During the formations of the bonding films 3a and 3b, it is possible to easily select a bonded region by merely controlling the film formation regions. This makes it possible to easily control, e.g., the bonding strength between the base members 1.

In addition, between the substrates 21 and 22 in the bonded body 5e, a gap 3c having a size corresponding to a total thickness of the bonding films 3a and 3b is formed in the region other than the predetermined region 350 (see FIG. 12D).

This means that it is possible to easily form closed spaces, flow paths or the like each having a desired shape between the substrates 21 and 22 by suitably changing the shape of the predetermined region 350 and the total thickness of the bonding films 3a and 3b.

In the manner described above, it is possible to obtain the bonded body 5e.

If necessary, the bonded body 5e thus obtained may be subjected to at least one of the steps [4A], [4B] and [4C] in the first embodiment.

For example, if the bonded body 5e is heated while compressing the same, the substrates 21 and 22 in the bonded body 5e come closer to each other. This accelerates dehydration and condensation of the hydroxyl groups and/or bonding of the dangling bonds in the interface between the bonding films 3a and 3b. Thus, unification (bonding) of the bonding films 3a and 3b is further progressed in the bonded portion formed in the predetermined region 350. Eventually, the bonding films 3a and 3b are substantially completely united.

The bonding methods of the respective embodiments described above can be used in bonding different kinds of members together.

Examples of an article (a bonded body) to be manufactured by these bonding methods include: semiconductor devices such as a transistor, a diode and a memory; piezoelectric devices such as a crystal oscillator and a surface acoustic wave device; optical devices such as a reflecting mirror, an optical lens, a diffraction grating and an optical filter; photoelectric conversion devices such as a solar cell; semiconductor substrates having semiconductor devices mounted thereon; insulating substrates having wirings or electrodes formed thereon; ink-jet type recording heads; parts of micro electromechanical systems such as a micro reactor and a micro mirror; sensor parts such as a pressure sensor and an acceleration sensor; package parts of semiconductor devices or electronic components; recording media such as a magnetic recording medium, a magneto-optical recording medium and an optical recording medium; parts for display devices such as a liquid crystal display device, an organic EL device and an electrophoretic display device; parts for fuel cells; and the like.

Liquid Droplet Ejection Head

Now, description will be made on an embodiment of a liquid droplet ejection head in which the bonded body according to the present invention is used.

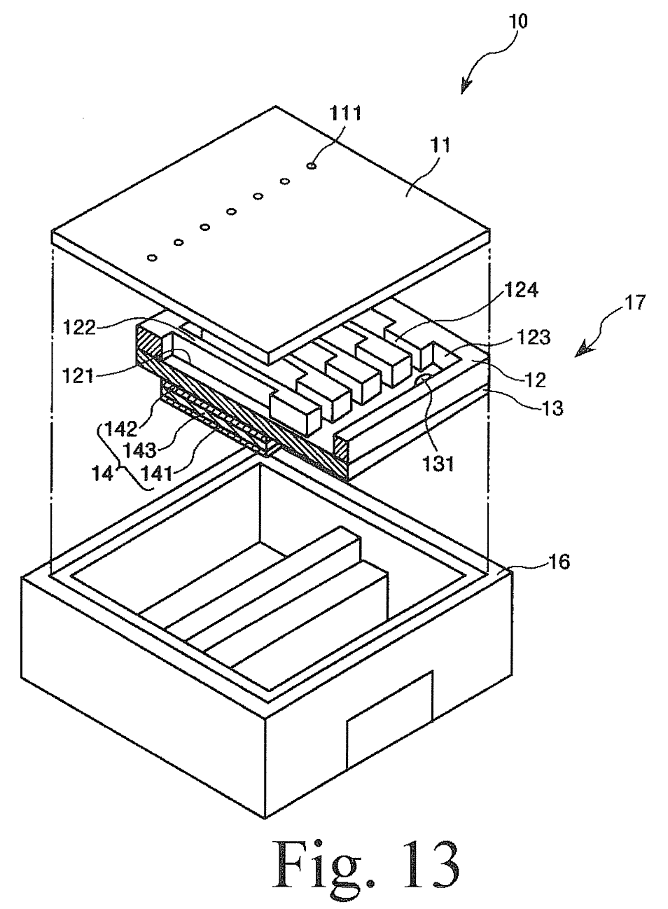

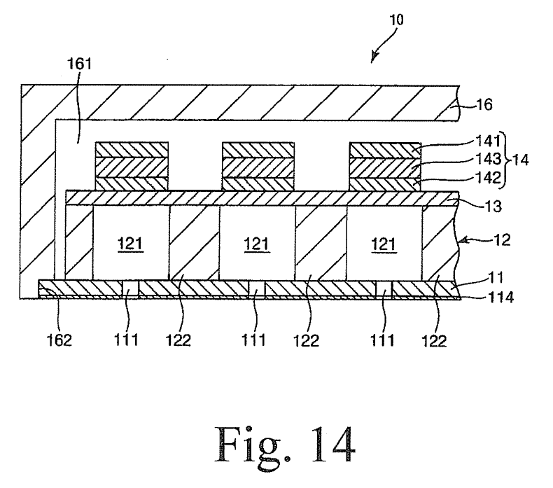

FIG. 13 is an exploded perspective view showing an ink jet type recording head (a liquid droplet ejection head) in which the bonded body according to the present invention is used. FIG. 14 is a section view illustrating major parts of the ink jet type recording head shown in FIG. 13.

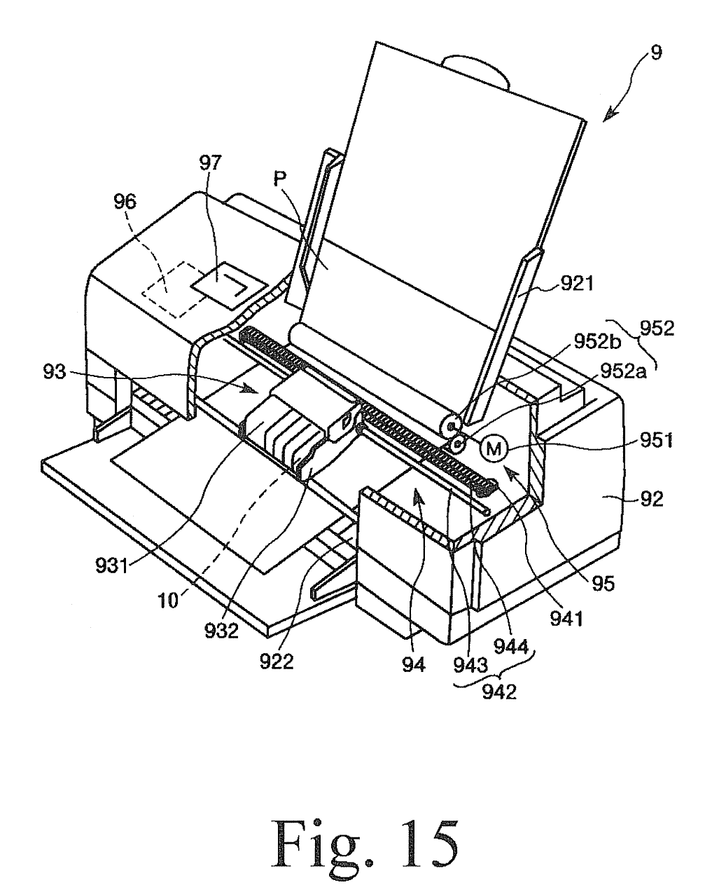

FIG. 15 is a schematic view showing one embodiment of an ink jet printer equipped with the ink jet type recording head shown in FIG. 13. In FIG. 13, the ink jet type recording head is shown in an inverted state as distinguished from a typical use state.

The ink jet type recording head 10 shown in FIG. 13 is mounted to the ink jet printer 9 shown in FIG. 15.

The ink jet printer 9 shown in FIG. 15 includes a printer body 92, a tray 921 provided in the upper rear portion of the printer body 92 for holding recording paper sheets P, a paper discharging port 922 provided in the lower front portion of the printer body 92 for discharging the recording paper sheets P therethrough, and an operation panel 97 provided on the upper surface of the printer body 92.

The operation panel 97 is formed from, e.g., a liquid crystal display, an organic EL display, an LED lamp or the like. The operation panel 97 includes a display portion (not shown) for displaying an error message and the like and an operation portion (not shown) formed from various kinds of switches.

Within the printer body 92, there are provided a printing device (a printing means) 94 having a reciprocating head unit 93, a paper sheet feeding device (a paper sheet feeding means) 95 for feeding the recording paper sheets P into the printing device 94 one by one and a control unit (a control means) 96 for controlling the printing device 94 and the paper sheet feeding device 95.

Under the control of the control unit 96, the paper sheet feeding device 95 feeds the recording paper sheets P one by one in an intermittent manner. The recording paper sheet P passes near the lower portion of the head unit 93. At this time, the head unit 93 makes reciprocating movement in a direction generally perpendicular to the feeding direction of the recording paper sheet P, thereby printing the recording paper sheet P.

In other words, an ink jet type printing operation is performed, during which time the reciprocating movement of the head unit 93 and the intermittent feeding of the recording paper sheets P act as primary scanning and secondary scanning, respectively.

The printing device 94 includes a head unit 93, a carriage motor 941 serving as a driving power source of the head unit 93 and a rotated by the carriage motor 941 for reciprocating the head unit 93.

The head unit 93 includes an ink jet type recording head 10 (hereinafter, simply referred to as “a head 10”) having a plurality of formed in the lower portion thereof, an ink cartridge 931 for supplying ink to the head 10 and a carriage 932 carrying the head 10 and the ink cartridge 931.

Full color printing becomes available by using, as the ink cartridge 931, a cartridge of the type filled with ink of four colors, i.e., yellow, cyan, magenta and black.

The reciprocating mechanism 942 includes a carriage guide shaft 943 whose opposite ends are supported on a frame (not shown) and a timing belt 944 extending parallel to the carriage guide shaft 943.

The carriage 932 is reciprocatingly supported by the carriage guide shaft 943 and fixedly secured to a portion of the timing belt 944.

If the timing belt 944 wound around a pulley is caused to run in forward and reverse directions by operating the carriage motor 941, the head unit 93 makes reciprocating movement along the carriage guide shaft 943. During this reciprocating movement, an appropriate amount of ink is ejected from the head 10 to print the recording paper sheets P.

The paper sheet feeding device 95 includes a paper sheet feeding motor 951 serving as a driving power source thereof and a pair of paper sheet feeding rollers 952 rotated by means of the paper sheet feeding motor 951.

The paper sheet feeding rollers 952 include a driven roller 952a and a driving roller 952b, both of which face toward each other in a vertical direction, with a paper sheet feeding path (the recording paper sheet P) remained therebetween. The driving roller 952b is connected to the paper sheet feeding motor 951.

Thus, the paper sheet feeding rollers 952 are able to feed the plurality of recording paper sheets P, which are held in the tray 921, toward the printing device 94 one by one. In place of the tray 921, it may be possible to employ a construction that can removably hold a paper sheet feeding cassette containing the recording paper sheets P.

The control unit 96 is designed to perform printing by controlling the printing device 94 and the paper sheet feeding device 95 based on the printing data inputted from a host computer, e.g., a personal computer or a digital camera.

Although not shown in the drawings, the control unit 96 is mainly comprised of a memory that stores a control program for controlling the respective parts and the like, a piezoelectric element driving circuit for driving piezoelectric elements (vibration sources) 14 to control an ink ejection timing, a driving circuit for driving the printing device 94 (the carriage motor 941), a driving circuit for driving the paper sheet feeding device 95 (the paper sheet feeding motor 951), a communication circuit for receiving printing data from a host computer, and a CPU electrically connected to the memory and the circuits for performing various kinds of control with respect to the respective parts.

Electrically connected to the CPU are a variety of sensors capable of detecting, e.g., the remaining amount of ink in the ink cartridge 931 and the position of the head unit 93.

The control unit 96 receives printing data through the communication circuit and then stores them in the memory. The CPU processes these printing data and outputs driving signals to the respective driving circuits, based on the data thus processed and the data inputted from the variety of sensors. Responsive to these signals, the piezoelectric elements 14, the printing device 94 and the paper sheet feeding device 95 come into operation, thereby printing the recording paper sheets P.

Hereinafter, the head 10 will be described in detail with reference to FIGS. 13 and 14.

The head 10 includes a head main body 17 and a base body 16 for receiving the head main body 17. The head main body 17 includes a nozzle plate 11, an ink chamber base plate 12, a vibration plate 13 and a plurality of piezoelectric elements (vibration sources) 14 bonded to the vibration plate 13. The head 10 constitutes a piezo jet type head of on-demand style.

The nozzle plate 11 is made of, e.g., a silicon-based material such as SiO₂, SiN or quartz glass, a metallic material such as Al, Fe, Ni, Cu or alloy containing these metals, an oxide-based material such as alumina or ferric oxide, a carbon-based material such as carbon black or graphite and the like.

A plurality of nozzle holes 111 for ejecting ink droplets therethrough is formed in the nozzle plate 11. The pitch of the nozzle holes 111 is suitably set according to the degree of printing accuracy.

The ink chamber base plate 12 is fixed or secured to the nozzle plate 11. In the ink chamber base plate 12, there are formed a plurality of ink chambers (cavities or pressure chambers) 121, a reservoir chamber 123 for reserving ink supplied from the ink cartridge 931 and a plurality of supply ports 124 through which ink is supplied from the reservoir chamber 123 to the respective ink chambers 121. These chambers 121, 123 and 124 are defined by the nozzle plate 11, the side walls (barrier walls) 122 and the below mentioned vibration plate 13.

The respective ink chambers 121 are formed into a reed shape (a rectangular shape) and are arranged in a corresponding relationship with the respective nozzle holes 111. Volume of each of the ink chambers 121 can be changed in response to vibration of the vibration plate 13 as described below. Ink is ejected from the ink chambers 121 by virtue of this volume change.

As a base material of which the ink chamber base plate 12 is made, it is possible to use, e.g., a monocrystalline silicon substrate, various kinds of glass substrates or various kinds of resin substrates. Since these substrates are all generally used in the art, use of these substrates makes it possible to reduce manufacturing cost of the head 10.

The vibration plate 13 is bonded to the opposite side of the ink chamber base plate 12 from the nozzle plate 11. The plurality of piezoelectric elements 14 are provided on the opposite side of the vibration plate 13 from the ink chamber base plate 12.

In a predetermined position of the vibration plate 13, a communication hole 131 is formed through a thickness of the vibration plate 13. Ink can be supplied from the ink cartridge 931 to the reservoir chamber 123 through the communication hole 131.

Each of the piezoelectric elements 14 includes an upper electrode 141, a lower electrode 142 and a piezoelectric body layer 143 interposed between the upper electrode 141 and the lower electrode 142. The piezoelectric elements 14 are arranged in alignment with the generally central portions of the respective ink chambers 121.

The piezoelectric elements 14 are electrically connected to the piezoelectric element driving circuit and are designed to be operated (vibrated or deformed) in response to the signals supplied from the piezoelectric element driving circuit.

The piezoelectric elements 14 act as vibration sources. The vibration plate 13 is vibrated by operation of the piezoelectric elements 14 and has a function of instantaneously increasing internal pressures of the ink chambers 121.

The base body 16 is made of, e.g., various kinds of resin materials or various kinds of metallic materials. The nozzle plate 11 is fixed to and supported by the base body 16. Specifically, in a state that the head main body 17 is received in a recess portion 161 of the base body 16, an edge of the nozzle plate 11 is supported on a shoulder 162 of the base body 16 extending along an outer circumference of the recess portion 161.

When bonding the nozzle plate 11 and the ink chamber base plate 12, the ink chamber base plate 12 and the vibration plate 13, and the nozzle plate 11 and the base body 16 as mentioned above, the bonding method of the present invention is used in at least one bonding point.

In other words, the bonded body of the present invention is used in at least one of a bonded body in which the nozzle plate 11 and the ink chamber base plate 12 are bonded together, a bonded body in which the ink chamber base plate 12 and the vibration plate 13 are bonded together, and a bonded body in which the nozzle plate 11 and the base body 16 are bonded together.

The head 10 described above exhibits increased bonding strength and chemical resistance in a bonding surface of the bonded portion, which in turn leads to increased durability and liquid tightness against the ink reserved in the respective ink chambers 121. As a result, the head 10 is rendered highly reliable.

Furthermore, highly reliable bonding is available even at an extremely low temperature. This is advantageous in that a head with an increased area can be fabricated from those materials having different linear expansion coefficients.

With the head 10 set forth above, no deformation occurs in the piezoelectric body layer 143 in the case where a predetermined ejection signal has not been inputted from the piezoelectric element driving circuit, that is, a voltage has not been applied between the upper electrode 141 and the lower electrode 142 of each of the piezoelectric elements 1.

For this reason, no deformation occurs in the vibration plate 13 and no change occurs in the volumes of the ink chambers 121. Therefore, ink droplets have not been ejected from the nozzle holes 111.

On the other hand, the piezoelectric body layer 143 is deformed in the case where a predetermined ejection signal is inputted from the piezoelectric element driving circuit, that is, a voltage is applied between the upper electrode 141 and the lower electrode 142 of each of the piezoelectric elements 1.

Thus, the vibration plate 13 is heavily deflected to change the volumes of the ink chambers 121. At this moment, the pressures within the ink chambers 121 are instantaneously increased and ink droplets are ejected from the nozzle holes 111.

when one ink ejection operation has ended, the piezoelectric element driving circuit ceases to apply a voltage between the upper electrode 141 and the lower electrode 142. Thus, the piezoelectric elements 14 are returned substantially to their original shapes, thereby increasing the volumes of the ink chambers 121.

At this time, a pressure acting from the ink cartridge 931 toward the nozzle holes 111 (a positive pressure) is imparted to the ink. This prevents an air from entering the ink chambers 121 through the nozzle holes 111, which ensures that the ink is supplied from the ink cartridge 931 (the reservoir chamber 123) to the ink chambers 121 in a quantity corresponding to the quantity of ink ejected.

By sequentially inputting ejection signals from the piezoelectric element driving circuit to the piezoelectric elements 14 lying in target printing positions, it is possible to print an arbitrary (desired) letter, figure or the like.

The head 10 may be provided with thermoelectric conversion elements in place of the piezoelectric elements 14. In other words, the head 10 may have a configuration in which ink is ejected using the thermal expansion of a material caused by thermoelectric conversion elements (which is sometimes called a bubble jet method wherein the term “bubble jet” is a registered trademark).

In the head 10 configured as above, a film 114 is formed on the nozzle plate 11 in an effort to impart liquid repellency thereto. By doing so, it is possible to reliably prevent ink droplets from adhering to peripheries of the nozzle holes 111, which would otherwise occur when the ink droplets are ejected from the nozzle holes 111.

As a result, it becomes possible to make sure that the ink droplets ejected from the nozzle holes 111 are reliably landed (hit) on target regions.

Wiring Board

Now, description will be made on an embodiment of a wiring board in which the bonded body according to the present invention is used.

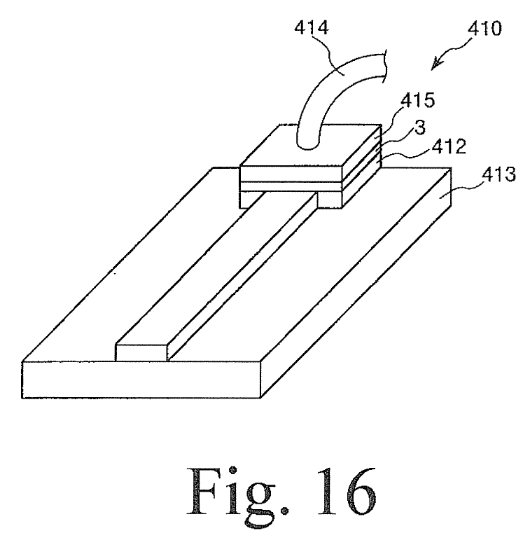

FIG. 16 is a perspective view showing a wiring board in which the bonded body according to the present invention is used.

A wiring board 410 shown in FIG. 16 includes an insulated board 413, an electrode 412 provided on the insulated board 413, a lead 414, an electrode 415 provided at one end of the lead 414 so as to be opposed to the electrode 412.

Further, bonding films 3 are respectively formed on an upper surface of the electrode 412 and a lower surface of the electrode 415. These bonding films 3 are bonded together using the above mentioned bonding method of the present invention.

Thus, the electrodes 412 and 415 are firmly bonded together by a single layer of the bonding films 3. This makes it possible to reliably prevent delamination (separation) between the electrodes 412 and 415 or the like, and to obtain a wiring board 410 having high reliability.

Further, the bonding film 3 is composed of a electrical conductive material, and also has a function of conducting between the electrodes 412 and 415. In this regard, even if the bonding film 3 has a very thin thickness, it can exhibit sufficient high bonding strength.

As a result, it is possible to reduce electrical resistance between the electrodes 412 and 415, and to reduce contact resistance therebetween. For this reason, electrical conductivity between the electrodes 412 and 415 can be further increased.

Moreover, a thickness of the bonding film 3 can be easily controlled with high accuracy as described above. This makes it possible to obtain a wiring board 410 having higher dimensional accuracy and to easily control electrical conductivity between the electrodes 412 and 415.

Although the base member, the bonding method and the bonded body according to the present invention have been described above based on the embodiments illustrated in the drawings, the present invention is not limited thereto.

As an alternative example, the bonding method according to the present invention may be a combination of two or more of the foregoing embodiments. If necessary, one or more arbitrary step may be added in the bonding method according to the present invention.

Further, although cases that two members (e.g., the base member and the opposite substrate, the two base members) are bonded together has been described in the above embodiments, the base member and the bonding method of the present invention can be used in a case that three or more members are bonded together.

### EXAMPLES

Next, description will be made on a number of concrete examples of the present invention.

1. Manufacturing Bonded Body

### Example 1

First, a monocrystalline silicon substrate having a length of 20 mm, a width of 20 mm and an average thickness of 1 mm was prepared as a substrate. A glass substrate having a length of 20 mm, a width of 20 mm and an average thickness of 1 mm was prepared as an opposite substrate.

Subsequently, the monocrystalline silicon substrate was set in the chamber 211 of the film forming apparatus 200 shown in FIG. 5 and subjected to a surface treatment using oxygen plasma.

Next, a bonding film having an average thickness of 100 nm was formed on the surface-treated surface of the monocrystalline silicon substrate using 2,4-pentadionato copper(II) as a raw material by means of a MOCVD method. In this regard, it is to be noted that the film forming conditions were as follows.

Film Forming Conditions

Atmosphere within chamber: nitrogen gas and hydrogen gas

Organic metal material (raw material): 2,4-pentadionato copper(II)

Flow rate of atomized organic metal material: 1 sccm

Carrier gas: nitrogen gas

Flow rate of carrier gas: 500 sccm

Flow rate of hydrogen gas: 0.2 sccm

Ultimate vacuum within chamber: 2×10⁻⁶ Torr

Pressure within chamber during film formation: 1×10⁻³ Torr

Temperature of substrate holder: 275° C.

Processing time: 10 minutes

The bonding film formed in this way contained Cu atoms as metal atoms. In the bonding film, a part of an organic compound contained in the 2,4-pentadionato copper(II) remained as leaving groups.

In this way, obtained was a base member in which the bonding film was formed on the monocrystalline silicon substrate (the base member of the present invention).

Then, an ultraviolet ray was irradiated on the obtained bonding film under the following conditions.

Ultraviolet Ray Irradiation Conditions

Composition of atmospheric gas: nitrogen gas

Temperature of atmospheric gas: 20° C.

Pressure of atmospheric gas: atmospheric pressure (100 kPa)

Wavelength of ultraviolet ray: 172 nm

Irradiation time of ultraviolet ray: 5 minutes

On the other hand, one surface of the glass substrate (the opposite substrate) was subjected to a surface treatment using oxygen plasma.

After one minute had lapsed from irradiation of the ultraviolet ray, the base member and the glass substrate were laminated together so that the ultraviolet ray-irradiated surface of the bonding film and the surface-treated surface of the glass substrate made contact with each other to thereby obtain a bonded body.

Then, the bonded body thus obtained was heated at a temperature of 120° C. while compressing the same under a pressure of 10 MPa and was maintained for fifteen minutes to thereby increase bonding strength between the base member and the glass substrate.

### Example 2

In Example 2, a bonded body was manufactured in the same manner as in the Example 1, except that the heating temperature was changed from 120° C. to 25° C. during the compressing and heating of the bonded body obtained.

### Examples 3 to 13

In each of Examples 3 to 13, a bonded body was manufactured in the same manner as in the Example 1, except that the constitute material of the substrate and the constitute material of the opposite substrate were changed to materials shown in Table 1.

### Example 14

First, in the same manner as in the Example 1, a monocrystalline silicon substrate (a substrate) and a glass substrate (an opposite substrate) were prepared and subjected to a surface treatment using oxygen plasma.

Then, a bonding film was formed on the surface-treated surface of the monocrystalline silicon substrate in the same manner as in the Example 1.

In this way, obtained was a base member in which the bonding film was formed on the monocrystalline silicon substrate (the base member of the present invention).

Subsequently, the base member and the glass substrate were laminated together so that the bonding film of the base member and the surface-treated surface of the glass substrate made contact with each other to thereby obtain a laminated body.

Next, an ultraviolet ray was irradiated to the laminated body from the side of the glass substrate under the following conditions.

Ultraviolet Ray Irradiation Conditions

Composition of atmospheric gas: nitrogen gas

Temperature of atmospheric gas: 20° C.

Pressure of atmospheric gas: atmospheric pressure (100 kPa)

Wavelength of ultraviolet ray: 172 nm

Irradiation time of ultraviolet ray: 5 minutes

In this way, the base member and the glass substrate were bonded together to thereby obtain a bonded body.

Then, the bonded body thus obtained was heated at a temperature of 80° C. while compressing the same under a pressure of 10 MPa and was maintained for fifteen minutes to thereby increase bonding strength between the base member and the glass substrate.

### Example 15

First, a monocrystalline silicon substrate having a length of 20 mm, a width of 20 mm and an average thickness of 1 mm was prepared as a substrate. A glass substrate having a length of 20 mm, a width of 20 mm and an average thickness of 1 mm was prepared as an opposite substrate.

Subsequently, both of the substrates were set in the chamber 211 of the film forming apparatus 200 shown in FIG. 5 and subjected to a surface treatment using oxygen plasma.

Next, bonding films each having an average thickness of 100 nm were formed on the surface-treated surfaces of the substrates using 2,4-pentadionato copper(II) as a raw material by means of a MOCVD method. In this regard, it is to be noted that the film forming conditions were as follows.

Film Forming Conditions

Atmosphere within chamber: nitrogen gas and hydrogen gas

Organic metal material (raw material): 2,4-pentadionato copper(II)

Flow rate of atomized organic metal material: 1 sccm

Carrier gas: nitrogen gas

Flow rate of carrier gas: 500 sccm

Flow rate of hydrogen gas: 0.2 sccm

Ultimate vacuum within chamber: 2×10⁻⁶ Torr

Pressure within chamber during film formation: 1×10⁻³ Torr

Temperature of substrate holder: 275° C.

Processing time: 10 minutes

In this way, obtained were a base member in which the bonding film was formed on the monocrystalline silicon substrate and a base member in which the bonding film was formed on the glass substrate (the base members of the present invention).

Then, an ultraviolet ray was irradiated on the obtained bonding films under the following conditions.

Ultraviolet Ray Irradiation Conditions

Composition of atmospheric gas: nitrogen gas

Temperature of atmospheric gas: 20° C.

Pressure of atmospheric gas: atmospheric pressure (100 kPa)

Wavelength of ultraviolet ray: 172 nm

Irradiation time of ultraviolet ray: 5 minutes

After one minute had lapsed from irradiation of the ultraviolet ray, the two base members were laminated together so that the ultraviolet ray-irradiated surfaces of the bonding films made contact with each other to thereby obtain a bonded body.

Then, the bonded body thus obtained was heated at a temperature of 120° C. while compressing the same under a pressure of 10 MPa and was maintained for fifteen minutes to thereby increase bonding strength between the two base members.

### Example 16

In Example 16, a bonded body was manufactured in the same manner as in the Example 15, except that the heating temperature was changed from 120° C. to 80° C. during the compressing and heating of the bonded body obtained.

### Examples 17 to 27

In each of Examples 17 to 27, a bonded body was manufactured in the same manner as in the Example 15, except that the constitute material of the substrate and the constitute material of the opposite substrate were changed to materials shown in Table 1.

### Example 28

First, in the same manner as in the Example 15, a monocrystalline silicon substrate (a substrate) and a glass substrate (an opposite substrate) were prepared and subjected to a surface treatment using oxygen plasma.

Then, bonding films were formed on the surface-treated surfaces of the substrates in the same manner as in the Example 15.

In this way, obtained were a base member in which the bonding film was formed on the monocrystalline silicon substrate and a base member in which the bonding film was formed on the glass substrate (the base members of the present invention).

Subsequently, the base members were laminated together so that the bonding films of the base members made contact with each other to thereby obtain a laminated body.

Next, an ultraviolet ray was irradiated on the laminated body from the side of the glass substrate under the following conditions.

Ultraviolet Ray Irradiation Conditions

Composition of atmospheric gas: nitrogen gas

Temperature of atmospheric gas: 20° C.

Pressure of atmospheric gas: atmospheric pressure (100 kPa)

Wavelength of ultraviolet ray: 172 nm

Irradiation time of ultraviolet ray: 5 minutes

In this way, the base members were bonded together to thereby obtain a bonded body.

Then, the bonded body thus obtained was heated at a temperature of 80° C. while compressing the same under a pressure of 10 MPa and was maintained for fifteen minutes to thereby increase bonding strength between the two base members.

### Example 29

First, a monocrystalline silicon substrate having a length of 20 mm, a width of 20 mm and an average thickness of 1 mm was prepared as a substrate. A glass substrate having a length of 20 mm, a width of 20 mm and an average thickness of 1 mm was prepared as an opposite substrate.

Subsequently, both of the substrates were set in the chamber 211 of the film forming apparatus 200 shown in FIG. 5, and subjected to a surface treatment using oxygen plasma.

Next, bonding films each having an average thickness of 100 nm were formed on the surface-treated surfaces of the substrates using 2,4-pentadionato copper(II) as a raw material by means of a MOCVD method. In this regard, it is to be noted that the film forming conditions were as follows.

Film Forming Conditions

Atmosphere within chamber: nitrogen gas and hydrogen gas

Organic metal material (raw material): 2,4-pentadionato copper(II)

Flow rate of atomized organic metal material: 1 sccm

Carrier gas: nitrogen gas

Flow rate of carrier gas: 500 sccm

Flow rate of hydrogen gas: 0.2 sccm

Ultimate vacuum within chamber: 2×10⁻⁶ Torr

Pressure within chamber during film formation: 1×10⁻³ Torr

Temperature of substrate holder: 275° C.

Processing time: 10 minutes

In this way, obtained were a base member in which the bonding film was formed on the monocrystalline silicon substrate and a base member in which the bonding film was formed on the glass substrate (the base members of the present invention).

Then, an ultraviolet ray was irradiated on the obtained bonding films under the following conditions. In this regard, it is to be noted that the ultraviolet ray was irradiated on the entirety of the surface of the bonding film provided on the monocrystalline silicon substrate and on a frame-shaped region having a width of 3 mm along a periphery of the surface of the bonding film provided on the glass substrate.

Ultraviolet Ray Irradiation Conditions

Composition of atmospheric gas: nitrogen gas

Temperature of atmospheric gas: 20° C.

Pressure of atmospheric gas: atmospheric pressure (100 kPa)

Wavelength of ultraviolet ray: 172 nm

Irradiation time of ultraviolet ray: 5 minutes

Subsequently, the two base members were laminated together so that the ultraviolet ray-irradiated surfaces of the bonding films made contact with each other to thereby obtain a bonded body.

Then, the bonded body thus obtained was heated at a temperature of 120° C. while compressing the same under a pressure of 10 MPa and was maintained for fifteen minutes to thereby increase bonding strength between the two base members.

### Example 30

In Example 30, a bonded body was manufactured in the same manner as in the Example 29, except that the heating temperature was changed from 120° C. to 80° C. during the compressing and heating of the bonded body obtained.

### Examples 31, 35 to 37, 39 and 40

In each of Examples 31, 35 to 37, 39 and 40, a bonded body was manufactured in the same manner as in the Example 29, except that the constitute material of the substrate and the constitute material of the opposite substrate were changed to materials shown in Table 2.

### Example 32

First, a monocrystalline silicon substrate having a length of 20 mm, a width of 20 mm and an average thickness of 1 mm was prepared as a substrate. A stainless steel substrate having a length of 20 mm, a width of 20 mm and an average thickness of 1 mm was prepared as an opposite substrate.

Subsequently, the monocrystalline silicon substrate was set in the chamber 211 of the film forming apparatus 200 shown in FIG. 5 and subjected to a surface treatment using oxygen plasma.

Next, a bonding film having an average thickness of 100 nm was formed on the surface-treated surface of the monocrystalline silicon substrate in the same manner as in the Example 29.

In this way, obtained was a base member in which the bonding film was formed on the monocrystalline silicon substrate (the base member of the present invention).

Then, an ultraviolet ray was irradiated on the bonding film in the same manner as in the Example 29. In this regard, it is to be noted that the ultraviolet ray was irradiated on a frame-shaped region having a width of 3 mm along a periphery of the surface of the bonding film.

Further, the stainless steel substrate was subjected to a surface treatment using oxygen plasma in the same manner as employed in the monocrystalline silicon substrate.

Subsequently, the base member and the stainless steel substrate were laminated together so that the ultraviolet ray-irradiated surface of the bonding film and the surface-treated surface of the stainless steel substrate made contact with each other to thereby obtain a bonded body.

Then, the bonded body thus obtained was heated at a temperature of 120° C. while compressing the same under a pressure of 10 MPa and was maintained for fifteen minutes to thereby increase bonding strength between the base member and the stainless steel substrate.

### Example 33

In Example 33, a bonded body was manufactured in the same manner as in the Example 32, except that the heating temperature was changed from 120° C. to 80° C. during the compressing and heating of the bonded body obtained.

### Examples 34, 38 and 41

In each of Examples 34, 38 and 41, a bonded body was manufactured in the same manner as in the Example 32, except that the constitute material of the substrate and the constitute material of the opposite substrate were changed to materials shown in Table 2.

### Comparative Examples 1 to 3

In each of Comparative Examples 1 to 3, a bonded body was manufactured in the same manner as in the Example 1, except that the constitute material of the substrate and the constitute material of the opposite substrate were changed to materials shown in Table 1, and the substrate and the opposite substrate were bonded together using an epoxy-based adhesive.

### Comparative Examples 4 to 6

In each of Comparative Examples 4 to 6, a bonded body was manufactured in the same manner as in the Example 1, except that the constitute material of the substrate and the constitute material of the opposite substrate were changed to materials shown in Table 1, and the substrate and the opposite substrate were bonded together using an Ag paste.

### Comparative Examples 7 to 9

In each of Comparative Examples 7 to 9, a bonded body was manufactured in the same manner as in the Example 1, except that the constitute material of the substrate and the constitute material of the opposite substrate were changed to materials shown in Table 2, and the substrate and the opposite substrate were partially bonded together using an epoxy-based adhesive in regions each having a width of 3 mm along a periphery of each substrate.

2. Evaluation of Bonded Body

2.1 Evaluation of Bonding Strength (Splitting Strength)

Bonding strength was measured for each of the bonded bodies obtained in the Examples 1 to 28 and the Comparative Examples 1 to 6.

The measurement of the bonding strength was performed by trying removal of the substrate from the opposite substrate. The bonding strength was defined by a value measured just before the substrate and the opposite substrate were separated with each other, and was evaluated according to criteria described below.

Evaluation Criteria for Bonding Strength

A: 10 MPa (100 kgf/cm²) or more

B: 5 MPa (50 kgf/cm²) or more, but less than 10 MPa (100 kgf/cm²)

C: 1 MPa (10 kgf/cm²) or more, but less than 5 MPa (50 kgf/cm²)

D: less than 1 MPa (10 kgf/cm²)

2.2 Evaluation of Dimensional Accuracy

Dimensional accuracy in a thickness direction was measured for each of the bonded bodies obtained in the Examples 1 to 41 and the Comparative Examples 1 to 9.

The evaluation of the dimensional accuracy was performed by measuring a thickness of each corner portion of the bonded body having a squire shape, calculating a difference between a maximum value and a minimum value of the thicknesses measured, and evaluating the difference according to criteria described below.

Evaluation Criteria for Dimensional Accuracy

A: less than 10 μm

B: 10 μm or more

2.3 Evaluation of Chemical Resistance

Each of the bonded bodies obtained in the Examples 1 to 41 and the Comparative Examples 1 to 9 was immersed in ink for an ink-jet printer (“HQ4”, produced by Seiko Epson Corporation), which was maintained at a temperature of 80° C., for three weeks.

Thereafter, the substrate was removed from the opposite substrate, and it was checked whether or not the ink penetrated into a bonding interface of the bonded body. The result of the check was evaluated according to criteria described below.

Evaluation Criteria for Chemical Resistance

A: Ink did not penetrate into the bonded body at all.

B: Ink penetrated into the corner portions of the bonded body slightly.

C: Ink penetrated along the edge portions of the bonded body.

D: Ink penetrated into the inside of the bonded body.

2.4 Evaluation of Resistivity

Resistivity in a bonded portion was measured for each of the bonded bodies obtained in the examples 12, 13, 26 and 27 and the comparative examples 5 and 6. The measured resistivity was evaluated according to criteria described bellow.

Evaluation Criteria for Resistivity

A: less than 1×10⁻³ Ω·cm

B: 1×10⁻³ Ω·cm or more

2.5 Evaluation of Shape Change

Shape changes of the substrate and the opposite substrate were checked for each of the bonded bodies obtained in the Examples 29 to 41 and the Comparative Examples 7 to 9.

Specifically, warp amounts of the substrate and the opposite substrate were measured before and after the bonded body was manufactured, a change between the warp amounts was evaluated according to criteria described below.

Evaluation Criteria for Change between Warp Amounts

A: The warp amounts of the substrate and the opposite substrate were changed hardly before and after the bonded body was manufactured.

B: The warp amounts of the substrate and the opposite substrate were changed slightly before and after the bonded body was manufactured.

C: The warp amounts of the substrate and the opposite substrate were changed rather significantly before and after the bonded body was manufactured.

D: The warp amounts of the substrate and the opposite substrate were changed significantly before and after the bonded body was manufactured.

Evaluation results of the above items 2.1 to 2.5 are shown in Tables 1 and 2.

TABLE 1

| | Conditions for Manufacturing Bonded Body | | | | | | | | | |
|---|---|---|---|---|---|---|---|---|---|---|
| | | | | Constituent | Irradiation | | | | | |
| | Constituent | Bonding Film | | Material of | of | | Evaluation Results | | | |
| | Material of | Raw Material of | Forming | Opposite | Ultraviolet | Heating | Bonding | Dimensional | Chemical | |
| | Substrate | Bonding Film | Position | Substrate | Ray | Temperature | Strength | Accuracy | Resistance | Resistivity |
| Ex. 1 | Silicon | 2,4-Pentadionato | Only | Glass | Before | 120° C. | B | A | A | — |
| Ex. 2 | Silicon | Copper(II) | Substrate | Glass | Laminating | 25° C. | B | A | A | — |
| Ex. 3 | Silicon | | | Silicon | | 120° C. | B | A | A | — |
| Ex. 4 | Silicon | | | Stainless | | 120° C. | B | A | A | — |
| | | | | Steel | | | | | | |
| Ex. 5 | Silicon | | | Aluminum | | 120° C. | B | A | A | — |
| Ex. 6 | Silicon | | | PET | | 120° C. | A | A | A | — |
| Ex. 7 | Silicon | | | PI | | 120° C. | A | A | A | — |
| Ex. 8 | Glass | | | Glass | | 120° C. | B | A | A | — |
| Ex. 9 | Glass | | | Stainless | | 120° C. | B | A | A | — |
| | | | | Steel | | | | | | |
| Ex. 10 | Stainless | | | PET | | 120° C. | A | A | A | — |
| | Steel | | | | | | | | | |
| Ex. 11 | Stainless | | | PI | | 120° C. | A | A | A | — |
| | Steel | | | | | | | | | |
| Ex. 12 | Stainless | | | Aluminum | | 120° C. | B | A | A | A |
| | Steel | | | | | | | | | |
| Ex. 13 | Stainless | | | Stainless | | 120° C. | B | A | A | A |
| | Steel | | | Steel | | | | | | |
| Ex. 14 | Silicon | | | Glass | After | 80° C. | B | A | A | — |
| | | | | | Laminating | | | | | |
| Ex. 15 | Silicon | | Substrate | Glass | Before | 120° C. | B | A | A | — |
| Ex. 16 | Silicon | | and | Glass | Laminating | 80° C. | B | A | A | — |
| Ex. 17 | Silicon | | Opposite | Silicon | | 120° C. | B | A | A | — |
| Ex. 18 | Silicon | | Substrate | Stainless | | 120° C. | B | A | A | — |
| | | | | Steel | | | | | | |
| Ex. 19 | Silicon | | | Aluminum | | 120° C. | B | A | A | — |
| Ex. 20 | Silicon | | | PET | | 120° C. | A | A | A | — |
| Ex. 21 | Silicon | | | PI | | 120° C. | A | A | A | — |
| Ex. 22 | Glass | | | Glass | | 120° C. | B | A | A | — |
| Ex. 23 | Glass | | | Stainless | | 120° C. | B | A | A | — |
| | | | | Steel | | | | | | |
| Ex. 24 | Stainless | | | PET | | 120° C. | A | A | A | — |
| | Steel | | | | | | | | | |
| Ex. 25 | Stainless | | | PI | | 120° C. | A | A | A | — |
| | Steel | | | | | | | | | |
| Ex. 26 | Stainless | | | Aluminum | | 120° C. | B | A | A | A |
| | Steel | | | | | | | | | |
| Ex. 27 | Stainless | | | Stainless | | 120° C. | B | A | A | A |
| | Steel | | | Steel | | | | | | |
| Ex. 28 | Silicon | | | Glass | After | 80° C. | B | A | A | — |
| | | | | | Laminating | | | | | |
| Comp. Ex. | Silicon | Epoxy-based | — | Glass | — | — | C | B | C | — |
| 1 | | | | | | | | | | |
| Comp. Ex. | Silicon | Adhesive | | Silicon | | | C | B | C | — |
| 2 | | | | | | | | | | |
| Comp. Ex. | Silicon | | | Stainless | | | C | B | C | — |
| 3 | | | | Steel | | | | | | |
| Comp. Ex. | Stainless | Conductive Paste | — | Glass | — | — | C | B | C | — |
| 4 | Steel | (Ag Paste) | | | | | | | | |
| Comp. Ex. | Stainless | | | Aluminum | | | C | B | C | B |
| 5 | Steel | | | | | | | | | |
| Comp. Ex. | Stainless | | | Stainless | | | C | B | C | B |
| 6 | Steel | | | Steel | | | | | | |

*PET: Polyethylene Terephthalate, PI: Polyimide

TABLE 2

| | Conditions for Manufacturing Bonded Body | | | | | | | | | |
|---|---|---|---|---|---|---|---|---|---|---|
| | | Bonding Film | | | Constituent | Irradiation | | Evaluation Results | | |
| | Constituent | Raw Material | | | Material of | of | | | | Change |
| | Material of | of | Bonding | Forming | Opposite | Ultraviolet | Heating | Dimensional | Chemical | of Warp |
| | Substrate | Bonding Film | region | Position | Substrate | Ray | Temperature | Accuracy | Resistance | Amounts |
| Ex. 29 | Silicon | 2,4- | A Part of | Substrate and | Glass | Before | 120° C. | A | A | A |
| | | Pentadionato | Surface of | Opposite | | Laminating | | | | |
| | | Copper(II) | Bonding | Substrate | | | | | | |
| Ex. 30 | Silicon | | Film | Substrate and | Glass | | 80° C. | A | A | A |
| | | | | Opposite | | | | | | |
| | | | | Substrate | | | | | | |
| Ex. 31 | Silicon | | | Substrate and | Silicon | | 120° C. | A | A | A |
| | | | | Opposite | | | | | | |
| | | | | Substrate | | | | | | |
| Ex. 32 | Silicon | | | Only Substrate | Stainless | | 120° C. | A | A | B |
| | | | | | Steel | | | | | |
| Ex. 33 | Silicon | | | Only Substrate | Stainless | | 80° C. | A | A | A |
| | | | | | Steel | | | | | |
| Ex. 34 | Silicon | | | Only Substrate | Aluminum | | 120° C. | A | A | B |
| Ex. 35 | Silicon | | | Substrate and | PET | | 120° C. | A | A | B |
| | | | | Opposite | | | | | | |
| | | | | Substrate | | | | | | |
| Ex. 36 | Silicon | | | Substrate and | PI | | 120° C. | A | A | B |
| | | | | Opposite | | | | | | |
| | | | | Substrate | | | | | | |
| Ex. 37 | Glass | | | Substrate and | Glass | | 120° C. | A | A | A |
| | | | | Opposite | | | | | | |
| | | | | Substrate | | | | | | |
| Ex. 38 | Glass | | | Only Substrate | Stainless | | 120° C. | A | A | B |
| | | | | | Steel | | | | | |
| Ex. 39 | Stainless | | | Substrate and | PET | | 120° C. | A | A | B |
| | Steel | | | Opposite | | | | | | |
| | | | | Substrate | | | | | | |
| Ex. 40 | Stainless | | | Substrate and | PI | | 120° C. | A | A | B |
| | Steel | | | Opposite | | | | | | |
| | | | | Substrate | | | | | | |
| Ex. 41 | Stainless | | | Only Substrate | Aluminum | | 120° C. | A | A | A |
| | Steel | | | | | | | | | |
| Comp. | Silicon | Epoxy-based | A Part of | — | Glass | — | — | B | C | A |
| Ex. 7 | | | | | | | | | | |
| Comp. | Silicon | Adhesive | Surface of | | Silicon | | | B | C | A |
| Ex. 8 | | | | | | | | | | |
| Comp. | Silicon | | Bonding | | Stainless | | | B | C | B |
| Ex. 9 | | | Film | | Steel | | | | | |

*PET: Polyethylene Terephthalate, PI: Polyimide

As is apparent in Tables 1 and 2, the bonded bodies obtained in the examples exhibited excellent characteristics in all the items of the bonding strength, the dimensional accuracy, the chemical resistance, and the resistivity. Further, the bonded bodies obtained in the Examples had the changes of the warp amounts smaller than those of the bonded bodies obtained in the Comparative Examples.

On the other hand, the bonded bodies obtained in the Comparative Examples did not have enough chemical resistance. Further, it was confirmed that the dimensional accuracy of the bonded bodies was particularly low. Moreover, the resistivity of the bonded bodies was high.

1. A base member with a bonding film, the base member being adapted to be bonded to an object through the bonding film thereof, comprising:
a substrate; and
a bonding film provided on the substrate, the bonding film containing metal atoms and leaving groups each composed of an organic ingredient, and having a surface,
wherein when energy is applied to at least a predetermined region of the surface of the bonding film, the leaving groups, which exist in the vicinity of the surface within the region, are removed from the bonding film so that the region develops a bonding property with respect to the object.

2. The base member as claimed in claim 1, wherein the bonding film is obtained by forming an organic metal material as a raw material into a film form using a metal organic chemical vapor deposition method.

3. The base member as claimed in claim 2, wherein the bonding film is formed under a low reducing atmosphere.

4. The base member as claimed in claim 2, wherein the leaving groups are derived from a part of an organic compound contained in the organic metal material that remains in the bonding film.

5. The base member as claimed in claim 2, wherein each of the leaving groups is composed of an atomic group containing a carbon atom as an essential element, and at least one kind selected from the group comprising a hydrogen atom, a nitrogen atom, a phosphorus atom, a sulfur atom and a halogen atom.

6. The base member as claimed in claim 5, wherein each of the leaving groups is an alkyl group.

7. The base member as claimed in claim 2, wherein the organic metal material is a metal complex.

8. The base member as claimed in claim 1, wherein the metal atoms are at least one kind selected from the group comprising copper, aluminum, zinc and iron.

9. The base member as claimed in claim 1, wherein an abundance ratio of the metal atoms to the carbon atoms contained in the bonding film is in the range of 3:7 to 7:3.

10. The base member as claimed in claim 1, the bonding film has electrical conductivity.

11. The base member as claimed in claim 1, wherein active hands are generated on the surface of the bonding film, after the leaving groups existing at least in the vicinity thereof are removed from the bonding film.

12. The base member as claimed in claim 11, wherein each of the active hands is a dangling bond or a hydroxyl group.

13. The base member as claimed in claim 1, wherein an average thickness of the bonding film is in the range of 1 to 1000 nm.

14. The base member as claimed in claim 1, wherein the bonding film is in the form of a solid having no fluidity.

15. The base member as claimed in claim 1, wherein the substrate has a plate shape.

16. The base member as claimed in claim 1, wherein at least a portion of the substrate on which the bonding film is provided is composed of a silicon material, a metal material or a glass material as a major component thereof.

17. The base member as claimed in claim 1, wherein a surface of the substrate on which the bonding film is provided has been, in advance, subjected to a surface treatment for improving bonding strength between the substrate and the bonding film.

18. The base member as claimed in claim 17, wherein the surface treatment is a plasma treatment.

19. The base member as claimed in claim 1, wherein an intermediate layer provided between the substrate and the bonding film.

20. The base member as claimed in claim 19, wherein the intermediate layer is composed of an oxide-based material as a major component thereof.

21. A bonding method of forming a bonded body in which the base member defined by claim 1 and an object are bonded together through the bonding film of the base member, comprising:
preparing the base member and the object;
applying energy to at least a predetermined region of a surface of the bonding film of the base member so that the region develops a bonding property with respect to the object; and
making the object and the base member close contact with each other through the bonding film, so that the object and the base member are bonded together due to the bonding property developed in the region, to thereby obtain the bonded body.

22. A bonding method of forming a bonded body in which the base member defined by claim 1 and an object are bonded together through the bonding film of the base member, the bonding film having a surface making contact with the object, comprising:
preparing the base member and the object;
making the object and the base member close contact with each other through the bonding film to obtain a laminated body in which the object and the base member are laminated together; and
applying energy to at least a predetermined region of the surface of the bonding film in the laminated body, so that the region develops a bonding property with respect to the object and the object and the base member are bonded together due to the bonding property developed in the region, to thereby obtain the bonded body.

23. The bonding method as claimed in claim 21, wherein the applying the energy is carried out by at least one method selected from the group comprising a method in which an energy beam is irradiated on the bonding film, a method in which the bonding film is heated and a method in which a compressive force is applied to the bonding film.

24. The bonding method as claimed in claim 23, wherein the energy beam is an ultraviolet ray having a wavelength of 126 to 300 nm.

25. The bonding method as claimed in claim 23, wherein a temperature of the heating is in the range of 25 to 200° C.

26. The bonding method as claimed in claim 23, wherein the compressive force is in the range of 0.2 to 10 MPa.

27. The bonding method as claimed in claim 21, wherein the applying the energy is carried out in an atmosphere.

28. The bonding method as claimed in claim 21, wherein the object has a surface which has been, in advance, subjected to a surface treatment for improving bonding strength between the object and the base member, and
wherein the bonding film of the base member makes close contact with the surface-treated surface of the object.

29. The bonding method as claimed in claim 21, wherein the object has a surface containing at least one group or substance selected from the group comprising a functional group, a radical, an open circular molecule, an unsaturated bond, a halogen atom and peroxide, and
wherein the bonding film of the base member makes close contact with the surface having the group or substance of the object.

30. The bonding method as claimed in claim 21, further comprising subjecting the bonded body to a treatment for improving bonding strength between the base member and the object.

31. The bonding method as claimed in claim 30, wherein the subjecting the treatment is carried out by at least one method selected from the group comprising a method in which an energy beam is irradiated on the bonded body, a method in which the bonded body is heated and a method in which a compressive force is applied to the bonded body.

32. A bonded body, comprising:
the base member defined by claim 1; and
an object bonded to the base member through the bonding film thereof.

33. A bonded body, comprising:
a first base member and a second base member each defined by claim 1,
wherein the first and second base members are bonded together by facing and bonding the bonding films thereof.

34. The bonding method as claimed in claim 22, wherein the applying the energy is carried out by at least one method selected from the group comprising a method in which an energy beam is irradiated on the bonding film, a method in which the bonding film is heated and a method in which a compressive force is applied to the bonding film.

35. The bonding method as claimed in claim 22, wherein the applying the energy is carried out in an atmosphere.

36. The bonding method as claimed in claim 22, wherein the object has a surface which has been, in advance, subjected to a surface treatment for improving bonding strength between the object and the base member, and
wherein the bonding film of the base member makes close contact with the surface-treated surface of the object.

37. The bonding method as claimed in claim 22, wherein the object has a surface containing at least one group or substance selected from the group comprising a functional group, a radical, an open circular molecule, an unsaturated bond, a halogen atom and peroxide, and
wherein the bonding film of the base member makes close contact with the surface having the group or substance of the object.

38. The bonding method as claimed in claim 22, further comprising subjecting the bonded body to a treatment for improving bonding strength between the base member and the object.
